(19) United States
(12) Patent Application Publication
(10) Pub. No.: US 2010/0218100 A1
(43) Pub. Date: Aug. 26, 2010

(54) PRESENTATION SYSTEM

(75) Inventors: Christopher J. Simon, Shawnee, KS (US); Aleksandr M. Koromyslov, Olathe, KS (US)

Correspondence Address: FOLEY & LARDNER LLP, 777 EAST WISCONSIN AVENUE, MILWAUKEE, WI, 53202-5306, US

(73) Assignee: HNTB Holdings, Ltd.

(21) Appl. No.: 12/469,520

(22) Filed: May 20, 2009

Related U.S. Application Data
(60) Provisional application No. 61/155,508, filed on Feb. 25, 2009.
(60) Provisional application No. 61/155,515, filed on Feb. 25, 2009.
(60) Provisional application No. 61/155,828, filed on Feb. 26, 2009.

(51) Int. Cl. G06F 3/01

(52) U.S. Cl. 715/731; 715/732

(57) ABSTRACT

A system for displaying slides of a presentation includes an editor module configured to generate a slide for the presentation based at least on content defined by a user. The system further includes a display module configured to generate display data for the presentation. The display data represents the slide of the presentation. The system further includes a user interface module configured to receive a selection of a portion of the slide based at least on a detected movement of a user input device across the slide. The display module is configured to enlarge the selected portion of the slide on the display in response to at least the movement of the user input device across the slide.

### CROSS-REFERENCE TO RELATED APPLICATIONS

This application claims the benefit under 35 U.S.C. §119(e) of U.S. Prov. Pat. App. 61/155,508, filed Feb. 25, 2009, entitled “Presentation System,” U.S. Prov. Pat. App. 61/155,515, filed Feb. 25, 2009, also entitled “Presentation System,” and U.S. Prov. Pat. App. 61/155,828, filed Feb. 26, 2009, also entitled “Presentation System,” all of which are incorporated herein by reference in their entirety.

### BACKGROUND

The present disclosure relates generally to the field of presentation systems. More specifically, the present disclosure relates to computer-based presentation systems.

Current computer-based presentation systems may employ a linear approach for the organization of presentation slides. Under such a linear approach, each slide may be organized at a position in the total slides with no particular hierarchical relationship to the other slides. A presenter using a linear presentation system desiring to skip to a slide earlier or later in the presentation may be forced to step through each slide in between the current slide and the desired slide. Alternatively, in order to avoid stepping through each of the intervening slides, the presenter may need to exit a formal presentation interface of the presentation system to skip directly to the desired slide.

### SUMMARY

According to one exemplary embodiment, a system for displaying slides of a presentation comprises an editor module, a display module and a user interface module. The editor module is configured to generate a slide for a presentation based at least on content defined by a user. The display module is configured to generate display data for the presentation. The display data represents the slide of the presentation. The user interface module is configured to receive a selection of a portion of the slide based at least on a detected movement of a user input device across the slide. The display module is configured to enlarge the selected portion of the slide on the display in response to at least the movement of the user input device across the slide.

According to another exemplary embodiment, a system for organizing slides related to a presentation comprises an editing module, a display module and a user input module. The editing module is configured to assign both a linear relationship and a tree relationship to each slide. The display module is configured to present the slides linearly and to display the tree relationship of the slides. The user input module is configured to receive a user selection of a node of the displayed tree relationship. The display module is configured to display a slide corresponding to the selected node in response to at least the user selection. When a new slide is created a user is prompted to assign a tree relationship position for the new slide.

According to another exemplary embodiment, a system for presenting slides related to a presentation comprises an navigation module, a display module and a user interface module. The navigation module is configured to receive a tree relationship for the slides from a memory and generate a navigation pane based at least on the tree relationship. The display module is configured to display the navigation pane and a representation of at least one slide in the navigation pane according to a hierarchical structure based at least on the tree relationship. The user interface module is configured to receive a user selection of a slide from the navigation pane at any of a plurality of levels of hierarchy in the hierarchical structure. The display module is configured to determine the at least one slide for which a representation is displayed in the navigation pane based on a level of detail provided by a user via the user interface module. The display module is configured to display the slide selected from the navigation pane.

According to another exemplary embodiment, a system for presenting slides related to a presentation comprises an editing module, a presentation module, a display module, and a user interface module. The editing module is configured to assign a tree relationship to the slides. The display module is configured to display a visual representation of the tree relationship on an editing screen and display the first slide determined by the presentation module in a presentation window. The user interface module is configured to allow a user to select a slide based at least on the visual representation of the tree relationship displayed on the editing screen. The presentation module is further configured to determine a second slide to display for the presentation based at least on the slide selected by the user.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying drawings, wherein like reference numerals refer to like elements, in which:

FIG. 1 is a block diagram of a presentation system according to an exemplary embodiment.

FIG. 2 is a process flow diagram that may be executed by the presentation system of FIG. 1 according to an exemplary embodiment.

FIG. 3 is a diagram of a process that may be used in conjunction with the presentation system of FIG. 1 according to an exemplary embodiment.

FIG. 4 is a block diagram of a presentation system according to another exemplary embodiment.

FIG. 5 is a process flow diagram that may be executed by the presentation system of FIG. 4 according to an exemplary embodiment.

FIGS. 6 through 13 are screenshots of an editing interface that may be used with the presentation system of FIG. 4 according to an exemplary embodiment.

FIG. 14 is a block diagram of a presentation system according to another exemplary embodiment.

FIG. 15 is a process flow diagram that may be executed by the presentation system of FIG. 14 according to an exemplary embodiment.

FIG. 16 is a block diagram of a presentation system according to another exemplary embodiment.

FIG. 17 is a block diagram of a packaging system according to an exemplary embodiment.

FIGS. 18 through 24 are screenshots of an editing interface that may be used with the presentation system of FIG. 4 according to exemplary embodiments.

FIGS. 25 and 26 are graphical depictions of presentation systems according to exemplary embodiments.

### DETAILED DESCRIPTION

Embodiments described herein can provide an improved system for displaying and/or manipulating images, slides and other content related to a presentation. Various embodiments can be used to provide a rich media toolset for electronic presentations that are high-definition, interactive, easy-to-use, and/or provide for either linear or non-linear experiences, or both. Further, various embodiments can provide true content hierarchies at slide levels while also allowing for linear playback or navigation. Further, various embodiments may provide tools that are useful in both a formal presentation setting and a less formal question-and-answer setting. Further still, various embodiments may have rich media requirements related to, for example, HD video and interactive Flash interoperability built into their respective toolsets. Further still, various embodiments can provide a node-map content entry interface, advanced design templating, gesture zooming, and/or categorical index control.

Gesturing

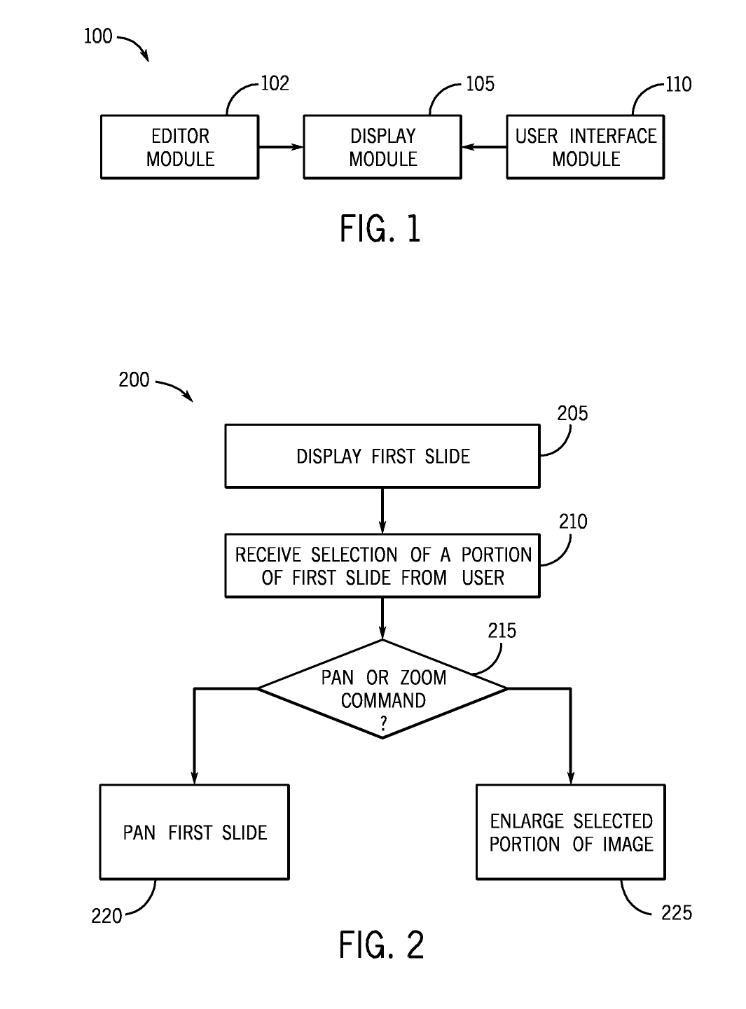

Referring now to FIG. 1, a block diagram of a presentation system 100 is shown, according to an exemplary embodiment. System 100 includes an editor module 102 configured to generate a slide for a presentation based at least on content defined by a user, a display module 105 configured to generate display data for the presentation representing the slide of the presentation, and a user interface module 110 configured to receive a selection of a portion of the slide based at least on a detected movement of a user input device across the slide. The movement may be any kind of movement, such as a circular motion, a linear motion, a rectangular motion, a touch, an abstract motion that does not resemble any particular geometric shape, etc. Display module 105 is configured to select, enlarge, and/or pan the selected portion of the slide on the display in response to at least the movement of the user input device across the slide. In some embodiments, the display may be a large screen display configured for use with presentations (e.g., not a standard laptop and/or desktop computer display, handheld computer display, cellular phone display, portable multimedia device display, etc.). The display may have a diagonal length of at least 40 inches. The display may be configured such that content shown on the display may be viewed from at least 20 feet away from the display. The display may be configured so that it can be viewed by a large group of people (e.g., 20 or more, 50 or more, 100 or more, etc.) during a presentation. The display may be configured for use in a conference room. The display may be an LCD, plasma, DLP, projection screen display, or other display. The display may be configured to be mounted on a wall. In some embodiments, the display may be a SMART Board, available from SMART Technologies ULC of Calgary, Alberta, Canada. In other embodiments, the display may be an eBeam device, available from Lucidia, Inc. of San Carlos, Calif. Content may comprise a slide, video data, image data, audio data, audio/visual data, textual data, data downloaded from a web site (e.g., in a markup language format), word processing data, spreadsheet data, project files, etc.

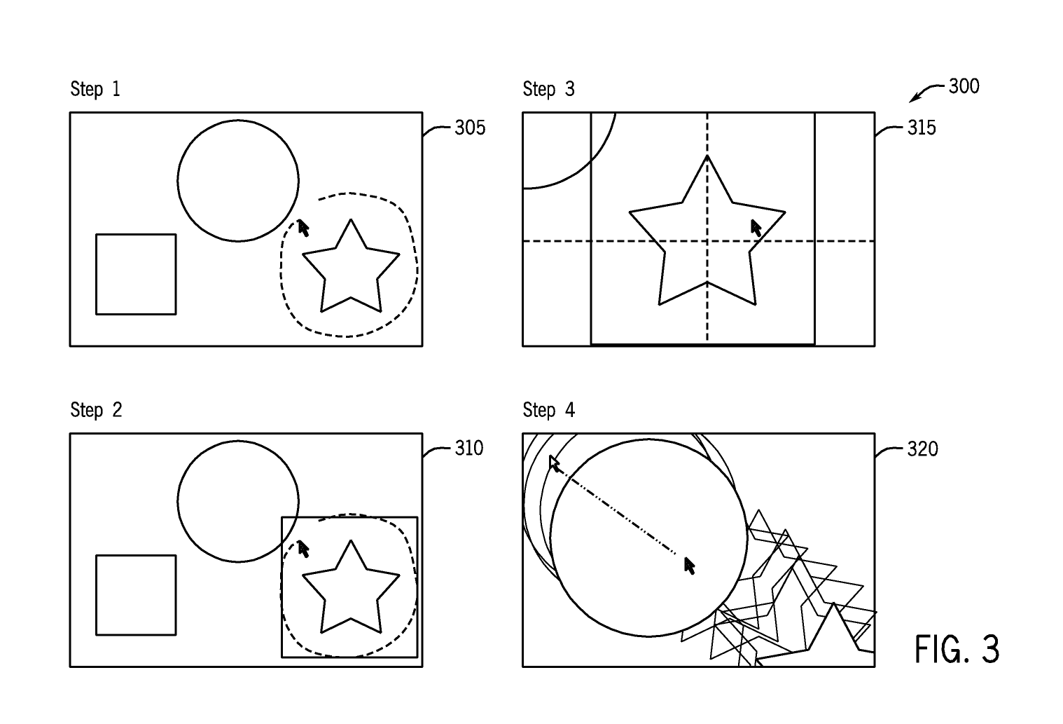

Referring now to FIG. 2, a process flow diagram of a process 200 that may be performed by system 100 is described, according to an exemplary embodiment. At step 205, display module 105 displays a slide related to a presentation on the display. At step 210, user interface module 110 receives a selection of a portion of the slide from a user. The selection is based on the movement of a user input device across the slide. The user input device may be any device configured to allow a user to communicate with user interface module 110. In some embodiments, user interface module 110 may receive user input from a computer mouse. In other embodiments, user interface module 110 may receive user input from a sensor configured to sense movement on or near the display. For example, the display may be a touch-sensitive display configured to sense a pointing object such as a human hand or a pen touching the surface of the display. In other embodiments, the display may not be a touch-sensitive display but may have a touch-sensitive overlay device configured to sense a pointing object touching the surface of the overlay. In still further embodiments, an infrared sensing device may be coupled or located proximate to the display and may be configured to sense movement near the surface of the display via an infrared grid. In still further embodiments, an image sensor may be located in front of the display and configured to sense when a pointing object is near the surface of the display. Such embodiments may permit a user to control presentation system 100 by gesturing, waving, dragging, pushing, or otherwise moving the user's finger or another pointing object such as a pen. In various embodiments, user interface module 110 may support single-touch input and/or multi-touch input. The user input may include data that represents a first point and a second point on the first image displayed at step 205. In one embodiment, the first point and second point may be horizontal and/or vertical coordinates on a display. In other embodiments, the first coordinate may be a coordinate on a display and the second coordinate may be a position relative to the first coordinate.

At step 215, display module 105 determines whether user interface module 110 received a pan command or a zoom command from the user. In some embodiments, the determination as to whether user interface module 110 received a pan command or a zoom command may be based on a type of movement of a user input device received by user interface module 110. For example, a curved or arced movement of a user input device may represent a zoom command and a straight or linear movement may represent a pan command. Other movements of a user input device may be used to represent each of the pan command and zoom command as well. User interface module 110 may be configured to instruct display module 105 to pan the slide upon receipt of at least one further user input (e.g., a pan command from a mouse or hand motion). If user interface module 110 received a pan command, process 200 proceeds to step 220. At step 220, display module 105 pans the slide. The direction and magnitude of the panning of the slide may be based on the extent of the movement associated with the user selection received at step 210. If the user interface module received a zoom command, process 200 proceeds from step 215 to step 225. At step 225, display module 105 enlarges the selected portion of the slide. In some embodiments, the area may be based on a predetermined display characteristic (e.g., aspect ratio, resolution, etc.). For example, a gesture of a horizontal line may be received, comprising end points (x1, y1) and (x2, y2). The display module may be configured to determine that the aspect ratio of the image portion selected is different than an aspect ratio of a display coupled to the system. The display module may then be configured to determine a new end point (x3, y3) based on either of (x1, y1) and (x2, y2), and based on the aspect ratio of the display. The display module may then be configured to redraw the image portion to fill the screen size of the display.

Referring now to FIG. 3, a diagram 300 of a process that may be used in conjunction with system 100 is shown, according to an exemplary embodiment. At step 305, a user may use the user input device to draw a shape around the area which the user desires to zoom into. Any shape, including an imaginative shape, may be used. In some embodiments, the user may draw through or over the desired zooming area. User interface module 110 receives a selection of the portion of the slide based on the drawing movement of the user. At step 310, system 100 creates a bounding box around the area selected by the user. System 100 may determine the size and position of the bounding box based on coordinates associated with the movement of the user input device. For example, system 100 may be configured to determine the outermost horizontal (or “x”) and vertical (or “y”) values or coordinates associated with the movement and create the bounding box based on those values or coordinates. User interface module 110 may be configured to register all user input device coordinates from the beginning of the user's movement until the end of the user's movement. At step 315, system 100 calculates the size and position of the selected area and display module 105 scales and/or pans the associated image to fit the selected area into a media container in a slide. At step 320, a user may pan the resulting zoomed image or scale the image back to its original size. In some embodiments, a user may pan the image by selecting and moving the user input device along the image. In some embodiments, a user may scale the image back to its original size by selecting, clicking or pressing the image. In still further embodiments, a minimum movement distance or minimum distance between start and end points may be used to prevent accidental zooming or panning of an image.

Editor

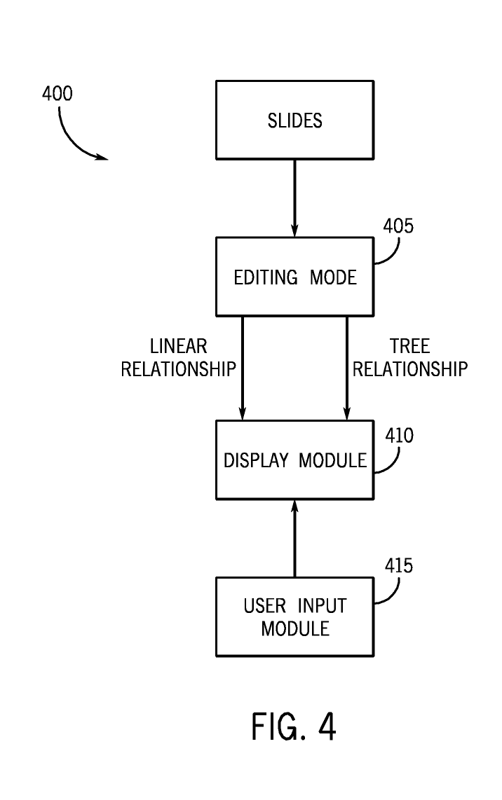

Referring now to FIG. 4, a block diagram of a presentation system 400 is shown, according to an exemplary embodiment. Presentation system 400 includes an editing module 405, a display module 410 and a user input module 415. Editing module 405 is configured to assign both a linear relationship and a tree relationship to each slide in a presentation. Display module 410 is configured to receive the linear relationship and the tree relationship assigned to each slide in the presentation. User input module 415 is configured to receive a user selection of a node of the displayed tree relationship. Display module 410 is configured to display a slide corresponding to the selected node in response to at least the user selection. Presentation system 400 may be used to organize slides related to a presentation. In some embodiments, presentation system 400 may be used to organize slides in real-time while the presentation is being presented. Presentation system 400 may be configured to allow a specific set of users or anyone to edit the slides and/or order of a presentation.

Editing module 405 is configured to assign a linear relationship and a tree relationship to each of the slides in a presentation. Editing module 405 may assign a linear relationship by defining an order in which the slides may be presented if all slides are presented in order from first to last, which may be assigned based on inputs from the user via user input module 415. In assigning each slide a linear relationship, editing module 405 may identify a first slide, a last slide, a next slide for the first slide, a previous slide for the last slide, and/or a next and previous slide for each of the other slides. Editing module 405 may assign a tree relationship by assigning a place for each slide in a hierarchical structure that may resemble a tree structure, which may have at least two levels, at least three levels, or any number of levels of nodes, each node representing a slide, which may comprise a textual slide or other content (e.g., video content, image file, word processing document, spreadsheet document, project file, etc.). In some embodiments, the hierarchical structure may also be determined in part according to a plurality of types of nodes, which may include categories, slides and/or images. Editing module 405 may assign a tree relationship by defining parent-child relationships among the slides, with parent slides having a higher-level position or a more general subject matter than their respective child slides. Several branches may be formed by the tree relationship. In some embodiments, when a user creates a new slide in the presentation, editing module 405 may display a prompt to the user via display module 410 requesting that the user assign a tree relationship position, or create a new node in the tree, for the new slide. In other embodiments, when a user creates a new slide in the presentation, editing module 405 may require the user to assign a tree relationship position for the new slide. In some embodiments, editing module 405 may also prompt and/or require the user to assign a linear relationship position for the new slide.

Display module 410 is configured to receive the linear relationship and tree relationship from editing module 405. Display module 410 may be configured to display the slides, or a representation of the slides (e.g., slide title, slide thumbnail, slide preview pane, etc.), on a display based on the linear relationship, tree relationship and/or both relationships. In some embodiments, display module 410 may be configured to display the slides, a representation of the slides, and/or a visual representation of the linear relationship and the tree relationship substantially simultaneously. In further exemplary embodiments, a visual representation of the linear relationship may include a preview pane, screen, window, etc. that allows a user to preview a portion of a linear slide presentation based on a node or slide selected based on a visual representation of the tree relationship. For example, a user may select a node or slide on an on-display tree structure formed based on the tree relationship using user input module 415 and the selected node or slide and/or a series of several (e.g., three, five, six, seven, etc.) slide previews may appear in a preview pane. The preview pane may be located on the same screen or window as the tree structure, on a different screen or window on the same display, or on a different display.

In some embodiments, display module 410 may be configured to hide one or more slides of a presentation. Display module 410 may be configured to skip over hidden slides during the presentation. In other embodiments, display module 410 may be configured to display a blank screen, hidden screen icon, or other visual indicator representing a hidden slide during the presentation. Slides to be hidden may be selected by a user via user input module 415 or may be determined by settings stored in a memory. In some embodiments, display module 410 may be configured to hide individual slides. In other embodiments, display module 410 may be configured to hide all slides beneath a selected slide in a branch of a hierarchy. For example, when a parent node is selected for hiding all of its children and related sub-children may also be hidden. In still further embodiments, display module 410 may be configured to hide all slides beneath a specified level in a hierarchy. In still further embodiments, display module 410 may be configured to graveyard a slide, or hide a slide and remove it from a slide hierarchy. If a slide is graveyarded, other slides in the presentation may be renumbered or given new slide identifiers to reflect that the graveyarded slide is no longer a part of the displayed presentation. One presentation may be used to create one or more subset presentations by hiding one or more slides of the master presentation. Hiding slides may reduce the need to copy slides from one presentation to create a subset presentation. Hiding slides also may allow content to be removed from a displayed presentation without deleting the content, so content may be recovered without having to recreate the content.

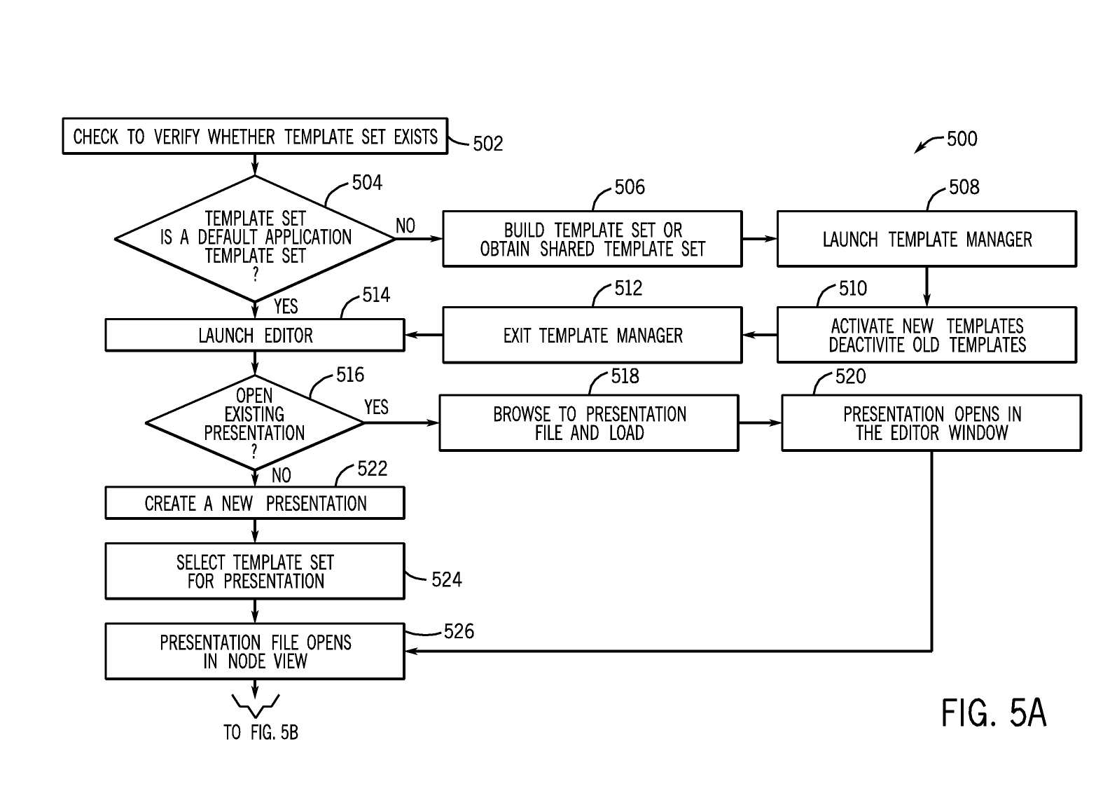

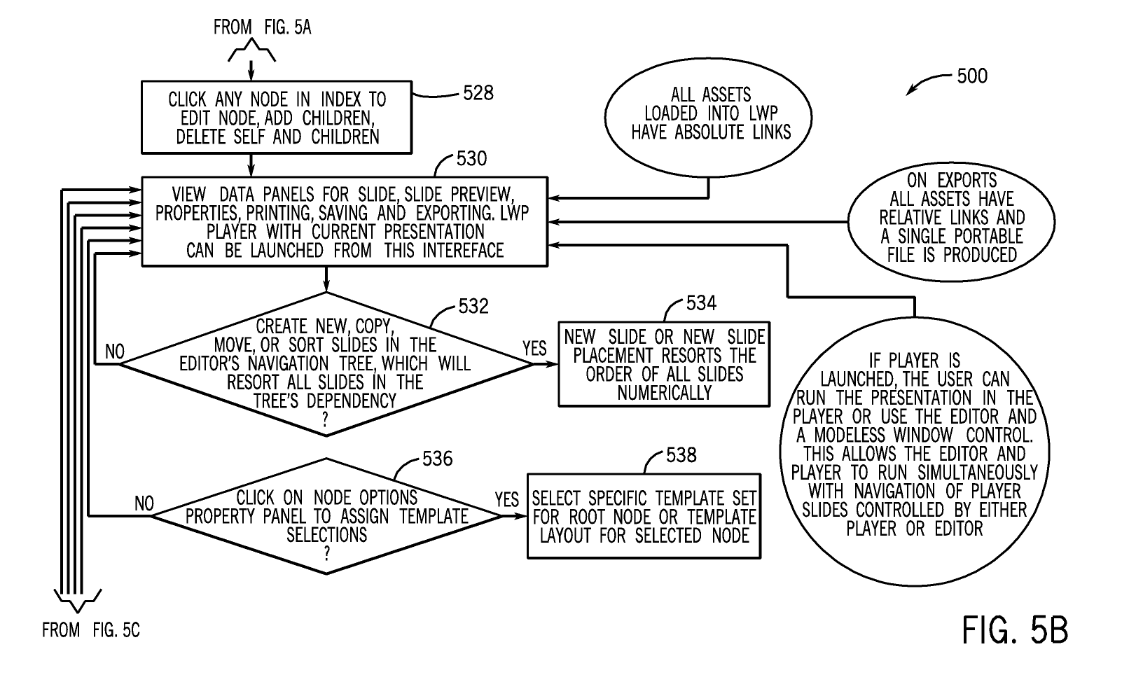

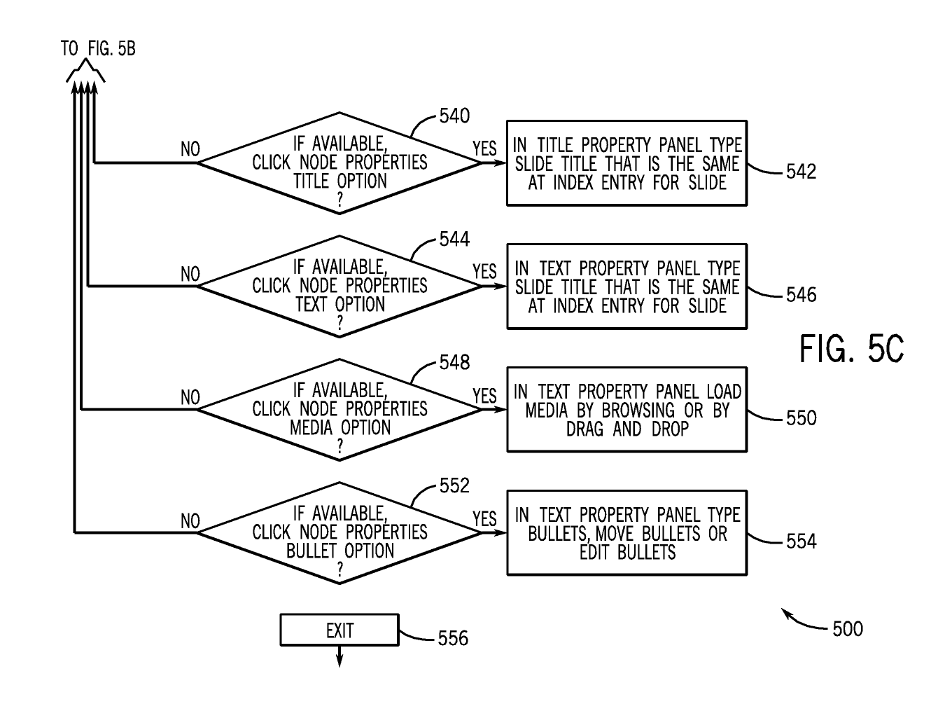

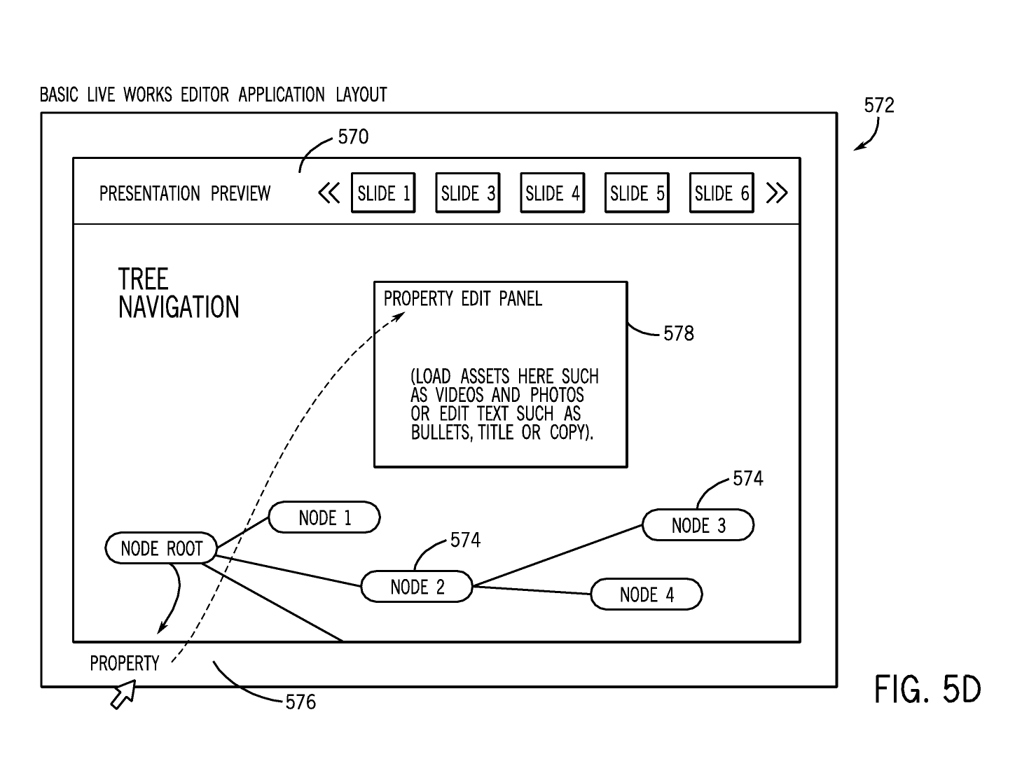

Referring now to FIG. 5, a process flow diagram of a process 500 that may be used with presentation system 400 is shown, according to an exemplary embodiment. At step 502, system 400 checks to verify whether a template set for the slides of a presentation exists. Format constraints may be provided by a template created and/or used for a presentation and may prevent unintentional deviations from a predetermined slide and/or content layout. Types, styles, sizes, colors, etc. may be locked in a template. Templates may be structured to provide media only, media and bullets, bullets, text, media and text, text only, etc. At step 504, system 400 determines whether the template set is a default application template set. If it is, system 400 proceeds to step 514. If it is not a default application template set, system 400 proceeds to step 506 and builds a template set or obtains a shared template set. At step 508, system 400 launches a template manager configured to manage various slide templates. At step 510, system 400 activates new templates and deactivates old templates to establish the appropriate templates to be used by editing module 405. At step 512, system 400 exits the template manager and proceeds to step 514. At step 514, system 400 launches an editor interface.

At step 516, user input module 415 determines whether the user would like to open an existing presentation file. If the user wishes to open an existing presentation file, system 400 proceeds to step 518 and display module 410 presents a browser to the user to select the presentation file. The presentation file is then loaded. At step 520, the presentation opens on the editor window or screen, and system 400 proceeds to step 526.

If the user does not wish to open an existing presentation file at step 516, system 400 proceeds to step 522 and creates a new presentation. At step 524, a user selection of a template set for the presentation is received by user input module 415 and system 400 proceeds to step 526.

At step 526, the presentation file opens in a node or tree view. At step 528, a user can click any node or slide in an index of the editing interface to edit the node or slide, add children, delete the node, and/or delete the node's children. At step 530, a user can view data panels associated with a particular slide, view a preview of the slide, view properties associated with the slide and/or the content embedded in the slide, print one or more slides on a printer or to a file, save the presentation file locally on a hard drive, remotely on a network drive, etc., and/or export the presentation. A player or presentation interface may also be launched from the editor interface at step 530. A user may run the presentation in the player interface or use the editor interface and a modeless window control. The editor interface and player interface may run simultaneously with navigation of slides in the player being controllable from either the editor interface or the player interface, or both. All assets or content loaded into system 400 may have absolute links. When a user chooses to export the presentation, the assets or content may have relative links and a single portable file may be produced.

At step 532, user input module 415 determines whether the user wishes to create a new slide and/or copy, move or sort slides in the tree displayed in the editing interface. If so, system 400 proceeds to step 534 and creates a new slide or copies, moves or sorts the slides and editing module 405 determines a new linear and/or tree relationship for the slides and resorts the order of the slides numerically. If not, system 400 returns to step 530.

At step 536, user input module 415 determines whether the user has selected a node options property panel to assign template selections. If so, system 400 proceeds to step 538 and selects a specific template set for a root node or a template layout for a selected node. If not, system 400 returns to step 530.

At step 540, user input module 415 determines whether the user has selected a node properties title option. If so, system 400 proceeds to step 542 and user input module 415 receives a slide title typed by the user in a title property panel. The slide title may be the same title that is used as the index entry for the slide. If not, system 400 proceeds to step 530.

At step 544, user input module 415 determines whether the user has selected a node properties text option. If so, system 400 proceeds to step 546 and user input module 415 receives a slide title type by the user in a text property panel. The slide title may be the same title that is used as the index entry for the slide. If not, system 400 proceeds to step 530.

At step 548, user input module 415 determines whether the user has selected a node properties media option. If so, system 400 proceeds to step 550 and user input module 415 receives a selection of media from a user (e.g., by a browser interface, dragging and dropping, etc.). System 400 then loads the media. If not, system 400 proceeds to step 530.

At step 552, user input module 415 determines whether the user has selected a node properties bullet option. If so, system 400 proceeds to step 554 and the user may type bullets, move bullets or edit bullets via user input module 415. At step 556, a user may exit system 400.

According to the exemplary embodiment of FIG. 5, an exemplary editor interface layout is also shown. The layout may include a presentation preview pane 570 that previews one or more slides. The slides 572 shown in the preview pane may change in response to user selection of a slide in a tree structure. The order of slides in presentation preview 570 may be based on a linear relationship between the slides. The layout may also have a tree structure or tree navigation pane or screen 572 on which a user can select and/or manipulate one or more slides or nodes 574. The layout may also have one or more property buttons 576 that may activate one or more property edit panels 578 when selected that may allow a user to, for example, load content such as video or images, edit text such as the title, edit bullets, etc.

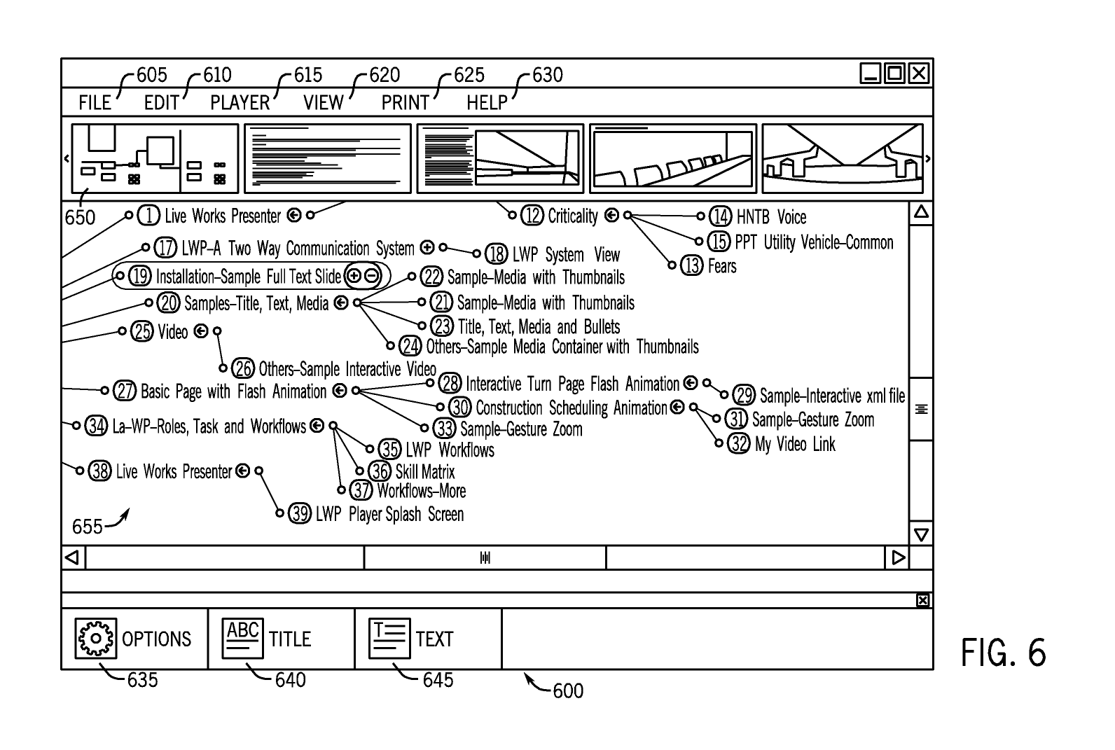

Referring now to FIG. 6, a screenshot of an editing interface 600 that may be used by system 400 is provided, according to an exemplary embodiment. Editing interface 600 has a plurality of menus (e.g., dropdown menus) selectable by a user via user input module 415. File menu 605 may permit a user to create a new presentation, open an existing presentation, save an open presentation, export a presentation and/or other files related to the presentation, import a presentation and/or other files related to the presentation, etc. Edit menu 610 may permit a user to copy a node (e.g., slide, image, video, etc.), cut a node, paste a node, delete a node, etc. Player menu 615 may allow a user to launch a player or presentation interface to present the slides from within editing interface 600. In some embodiments, the presentation may be launched in a modeless window or a presentation window. Player menu 615 may also allow a user to refresh a presentation running in an already open player interface. Player menu 615 may enable a user to alter one or more nodes, slides, media content, etc. of a presentation within editor interface 600 and refresh the presentation in the player interface to reflect the alterations without closing or otherwise changing the player interface. In some embodiments, such as when editing interface 600 is displayed on one display and a player interface is displayed on a separate display, editing interface 600 may be used to make changes to nodes, slides, content, etc. during a presentation without viewers of the presentation being aware that changes are being made. View menu 620 may allow a user to view one or more slides and/or select options related to the view of the editing interface. View menu 620 may allow a user to open and/or close a preview pane 650. Print command button 625 may allow a user to print one or more slides, a representation of preview pane 650, and/or a representation of tree structure 655. Help menu 630 may provide internal or external links to information regarding how to use system 400. Editing interface 600 may have a plurality of command buttons selectable by a user via user input module 415. The command buttons may be located in a slide properties panel. The command buttons may when selected cause editing interface 600 to present one or more slide property panels to a user. Options command button 635 may permit a user to select options related to a selected node or slide, such as selecting a particular template for a slide or group of slides. In some embodiments, the template options presented via options command button 635 may be based in part on the type of slide (e.g., text, text and image, image, video, text and video, etc.). Title command button 640 may allow a user to change the title of one or more slides. Text command button 645 may allow a user to edit the text of one or more slides.

Preview pane 650 may show a preview of one or more slides. Preview pane 650 may allow a user to preview slides and/or a linear presentation. In some embodiments, preview pane 650 may allow a user to preview slides and/or a presentation without changing the presentation being displayed in a presentation window that may have been opened by editing interface 600. Tree pane 655 shows a plurality of nodes and the tree relationship between the nodes. Tree pane 655 may show a visual representation of the tree relationship between the slides. In some embodiments, nodes as shown in tree pane 655 may represent slides. In other embodiments, nodes and/or slides may represent other content, such as text, pictures, videos, etc. The nodes connected by lines in tree pane 655 are related as parent-child nodes, where the node on the left of a connecting line is the parent of the node on the right of the line, and the node on the right of the line is a child of the node on the left. In some embodiments nodes may have multiple levels of hierarchy. For example, a node that is related as the child of the first or left-most node may be at a first level of hierarchy, and a node that is a child of that node may be at a second level of hierarchy.

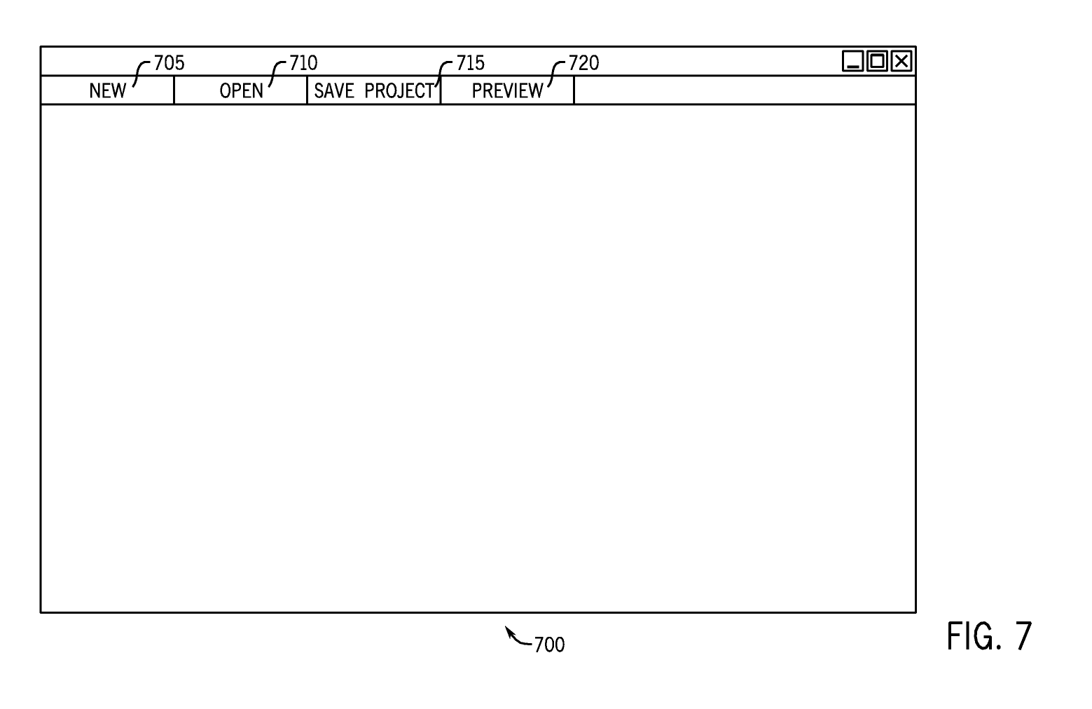

Referring now to FIGS. 7 through 13, screenshots of several editing interfaces that may be used by system 400 is provided, according to various exemplary embodiments. Referring specifically to FIG. 7, editing interface 700 has a plurality of command buttons selectable by a user via user input module 415. New command button 705 may open a new presentation. New command button 705 may cause a select project folder menu to open in which a user may select the desired location of the new presentation. In some embodiments, a project folder may be created prior to selecting new command button 705. Open command button 710 may open an existing presentation. The existing presentation may be opened by selecting a project file (e.g., an XML file). Save command button 715 may save an open presentation. Save command button 715 may pull referenced files into a deployment folder and save a primary reference file at the current project location. Cached data from a properties panel or node editing panel may be compiled when save command button 715 or a subsequent button such as a build button is selected. Preview command button 720 may open a preview of the current cached files.

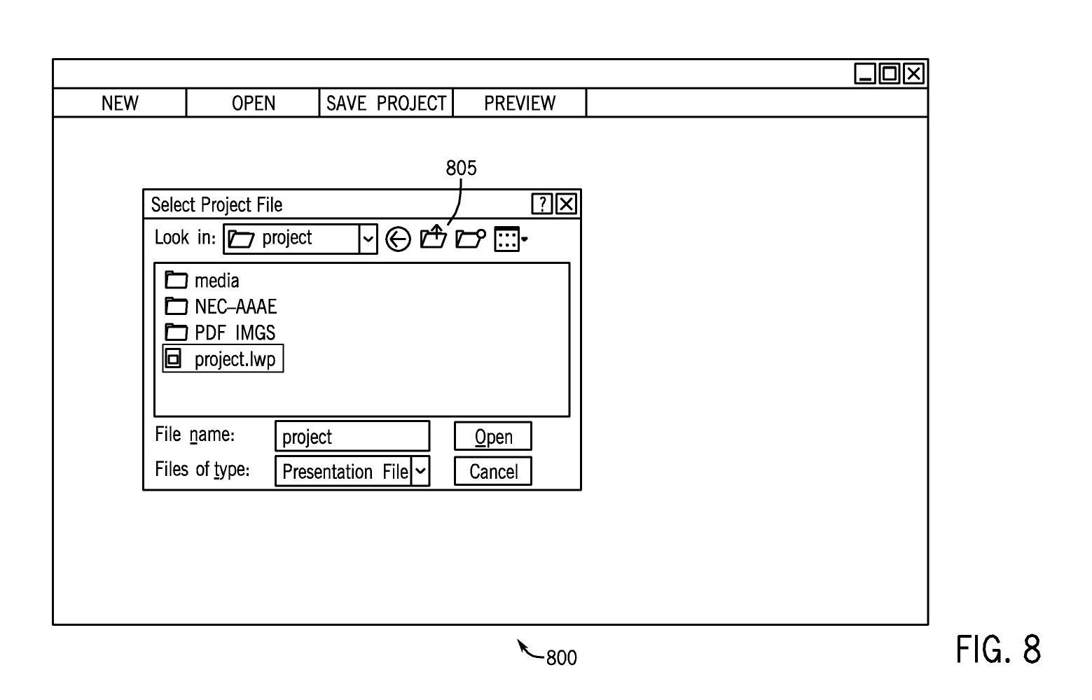

FIG. 8 shows an exemplary editing interface 800 having an open presentation browser window 805 that may be used to open a presentation.

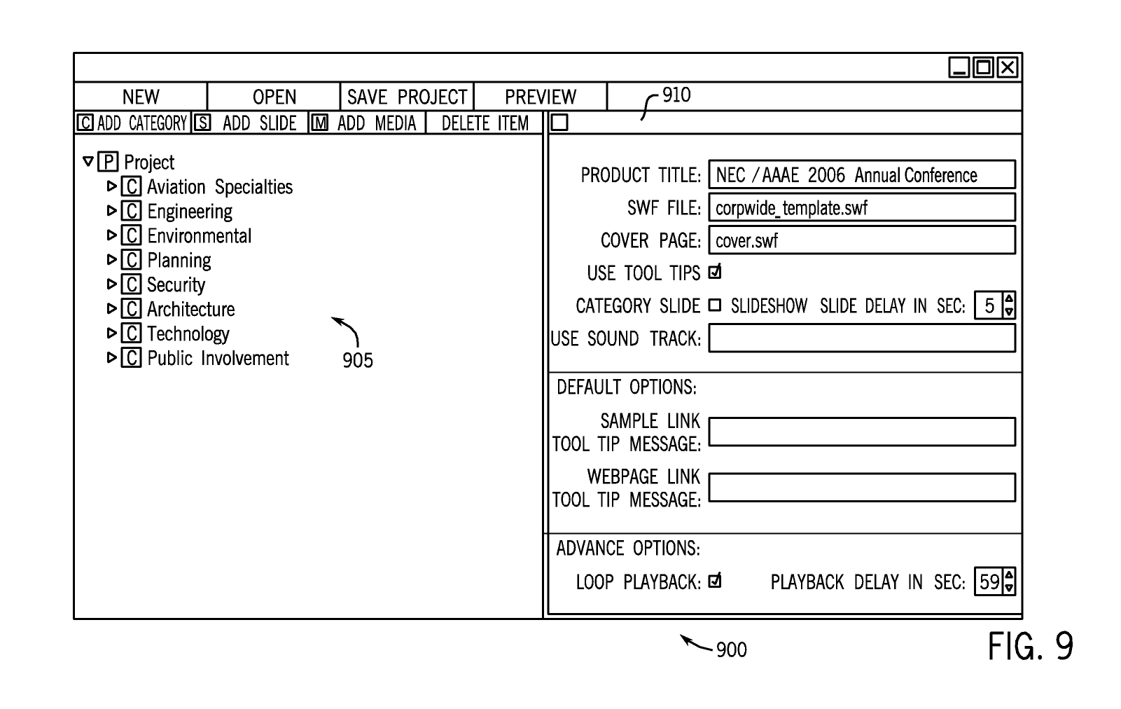

FIG. 9 shows an exemplary editing interface 900 having an index 905 that lists categories associated with a presentation, slides of the presentation, and/or media associated with the slides. Index 905 may include a command button interface that allows a user to add a category, slide or image, or delete a node. These commands may follow a strict hierarchy which dictates that categories contain slides which contain images. A category may relate to one or many slides, a single slide may relate to a single category and may relate to none or many images, and a single image may relate to a single slide. Adding a category, slide or image may create a visual representation of a new node in the index. The visual representation may include an indicator of the type of node. Deleting a node may delete children associated with the node. A warning window may alert the user that children may be deleted. Editing interface 900 also has a properties panel 910 that allows a user to view and change properties regarding a category, slide, or image, each of which may have different properties from one another. Properties panel 910 may include text entry fields such as title, description, link (absolute URL links or local file links), and tool tip descriptions that offer a description of the links. A user may also change properties regarding a presentation, such as how long the delay is between slides during the presentation. A user may be required to select a save command button to record any data entered. Properties panel 910 for images may contain a browse image name text field where a user can type or browse to a specific image file. A slide template may resize all images and/or video used in a presentation to one size. In some embodiments, for the image gallery and its template the image size may be 830 pixels wide by 590 pixels tall. A larger or smaller image may be used as well. In some embodiments, a larger or smaller image can be loaded and may be fit to match the presentation dimensions. Editing interface 900 may also have a project properties panel having text fields for project name, cover file, template file, category auto-building global presentation slide selector, global tool-tip selector, etc.

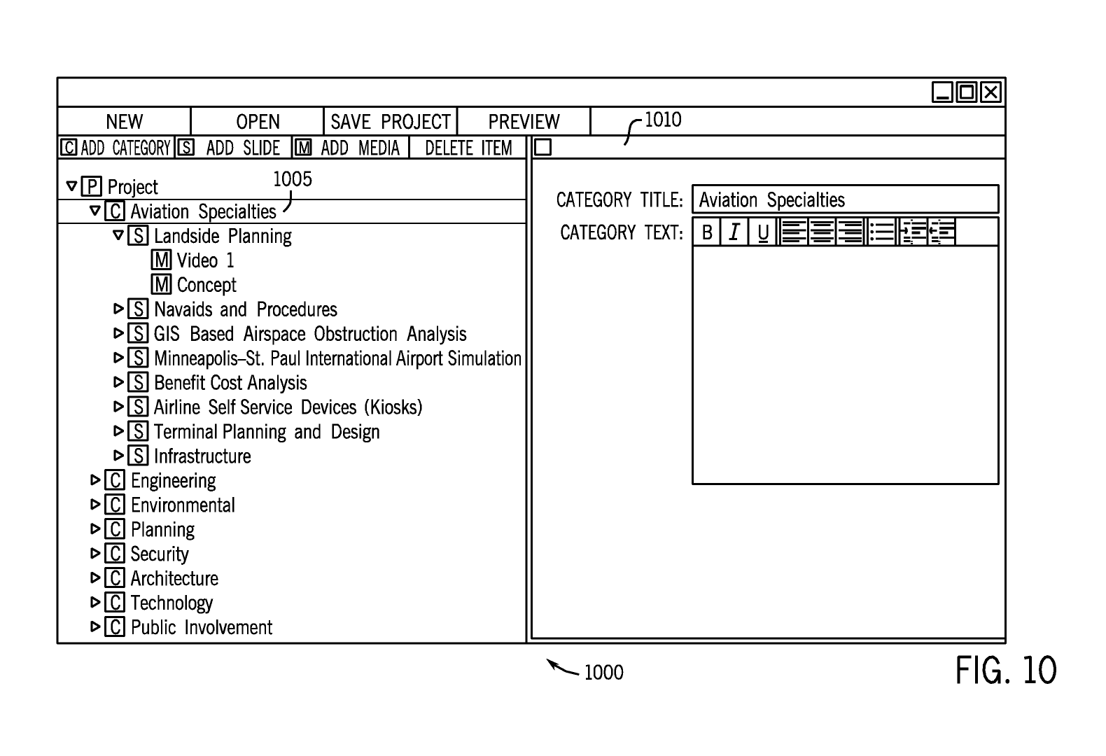

FIG. 10 shows an exemplary editing interface 1000 having an expanded index showing categories, slides and media. Editing interface 1000 also includes a text edit panel 1010 related to an index category 1005 that may appear to a user upon selection of a text command button.

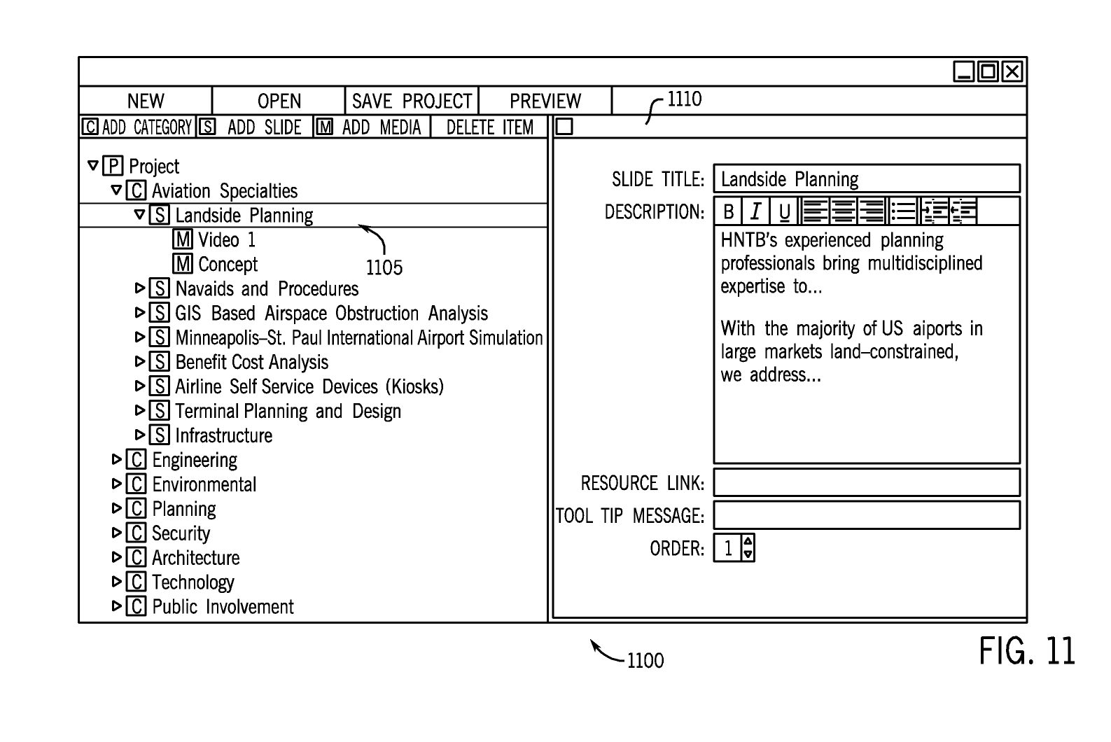

FIG. 11 shows an exemplary editing interface 1100 that includes a text edit panel 1110 related to an index slide 1105 that may appear to a user upon selection of a text command button. A user may change the order of the slide using text edit panel 1110.

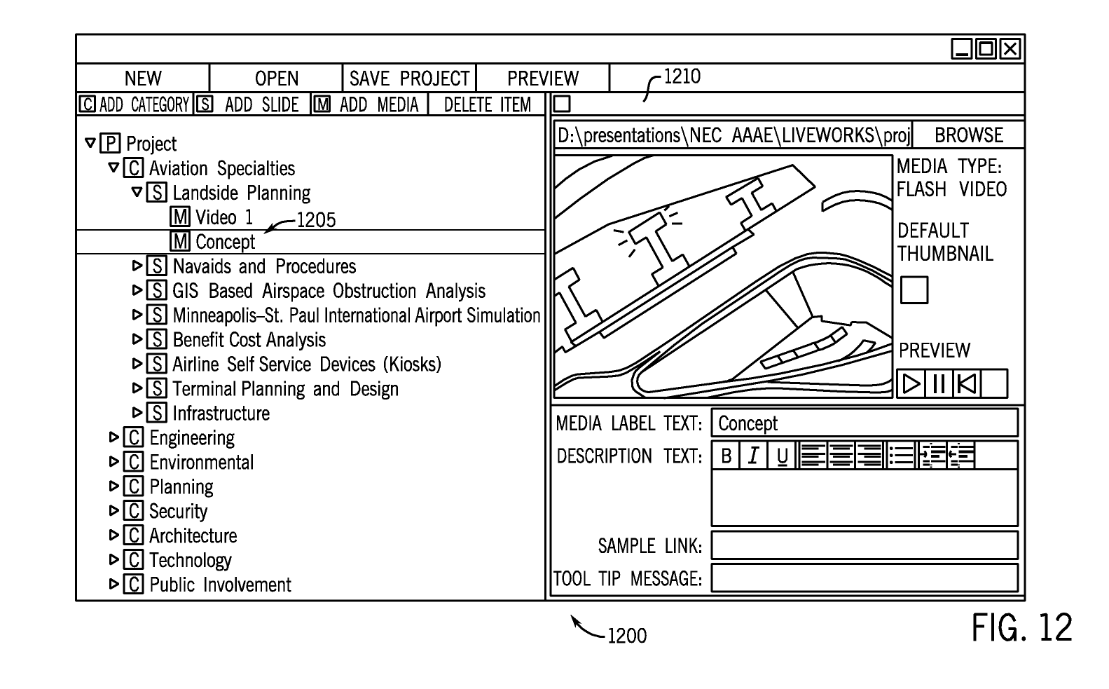

FIG. 12 shows an exemplary editing interface 1200 that includes a media edit panel 1210 related to index media 1205 that may appear to a user upon selection of a media edit command button. Index media 1205, as illustrated, is a video file. Media edit panel 1210 may include a view of the media content and information about the media content. A user may be allowed to edit a label associated with the media content and/or a textual description.

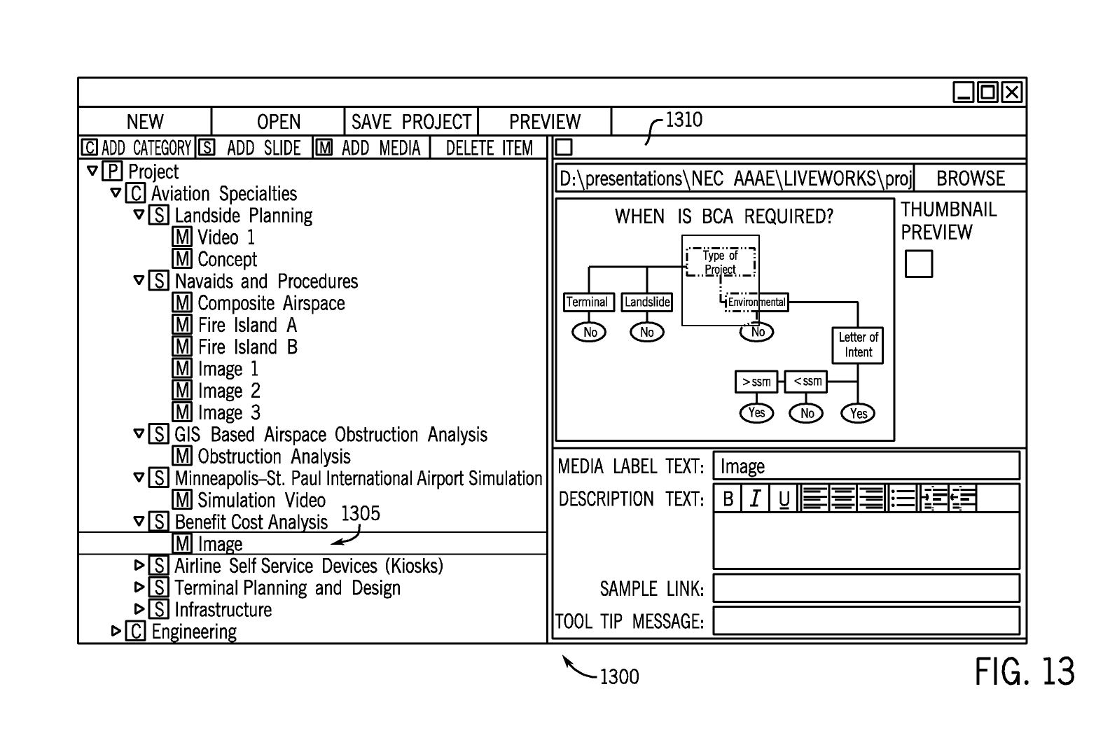

FIG. 13 shows an exemplary editing interface 1300 that includes a media edit panel 1310 related to index media 1305, which, as illustrated, is an image file. Media edit panel 1310 may permit a user to perform image editing functions on the image, such as cropping and/or resizing.

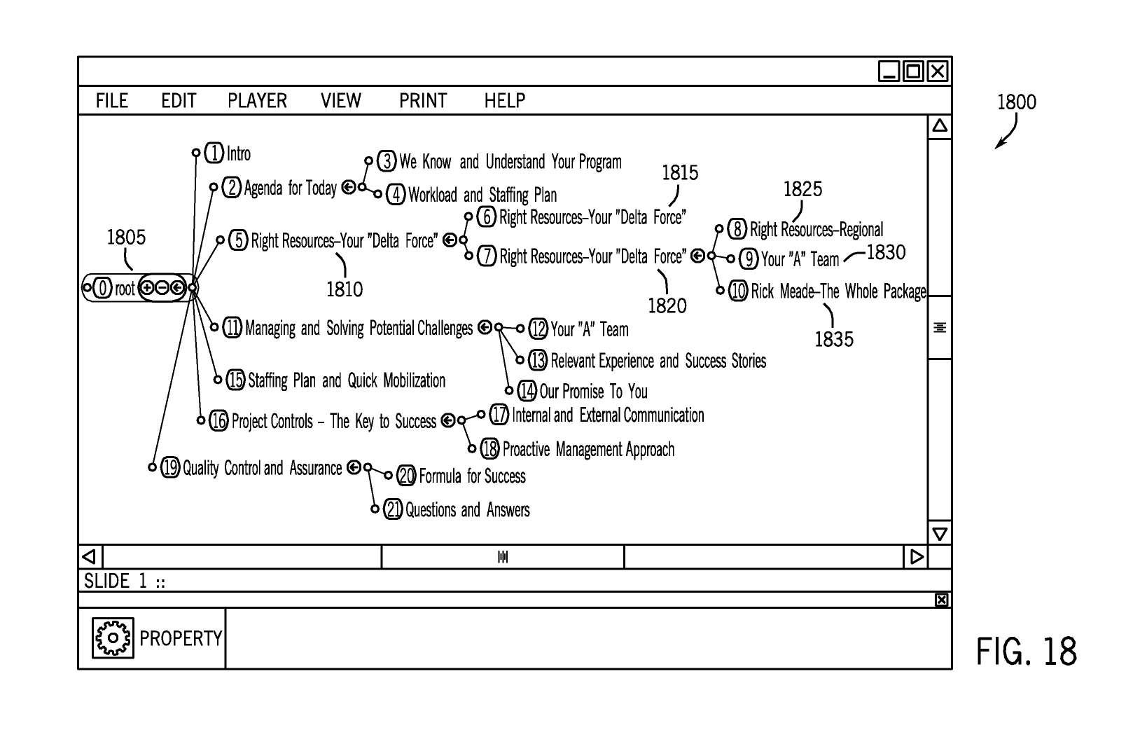

FIG. 18 shows an exemplary editing interface 1800 having a tree pane with a plurality of nodes organized according to a tree relationship. As illustrated, each node is represented by a number and a title (e.g., slide title). For example, node 1810 is represented by a “5” and the title “Right Resources—Your ‘Delta Force’.” The number may represent an order in a linear relationship, or an order in which the slides would be presented in a linear presentation. For example, in FIG. 18 node 1810 is represented by the number “5” and node 1815 is represented by the number “6” indicating that node 1810 would be displayed directly prior to node 1815 in a linear presentation. In other embodiments, the number may represent the order in which the slide was created, an importance level, a position in a hierarchy based on the tree relationship, etc. In other embodiments, nodes may be represented by images, textual descriptions, symbols, icons, etc.

The nodes may be organized based on the tree-based relationship. For example, node 1805 is the parent of node 1810 and the visual representation of nodes 1805 and 1810 are connected by a line to represent the parent-child relationship. Node 1810 is the parent of nodes 1815 and 1820 and the visual representation of nodes 1810 is connected by a line to that of nodes 1815 and 1820. Node 1820 is the parent of nodes 1825, 1830 and 1835, and the visual representation of node 1820 is connected by a line to that of nodes 1825, 1830 and 1835. In other embodiments, the relationship may be shown in other ways, such as through indentation, color, fonts, etc. In some embodiments, one or more nodes, groups of nodes, and/or hierarchy levels may be hidden in the tree pane. In the exemplary embodiment of FIG. 18, the children of a parent node may be hidden if a user selects a hide command button, represented as an arrow surrounded by a circle located next to the title of the parent node. For example, if the arrow next to node 1820 is selected, nodes 1825, 1830 and 1835 (i.e., the children of node 1820) may be hidden.

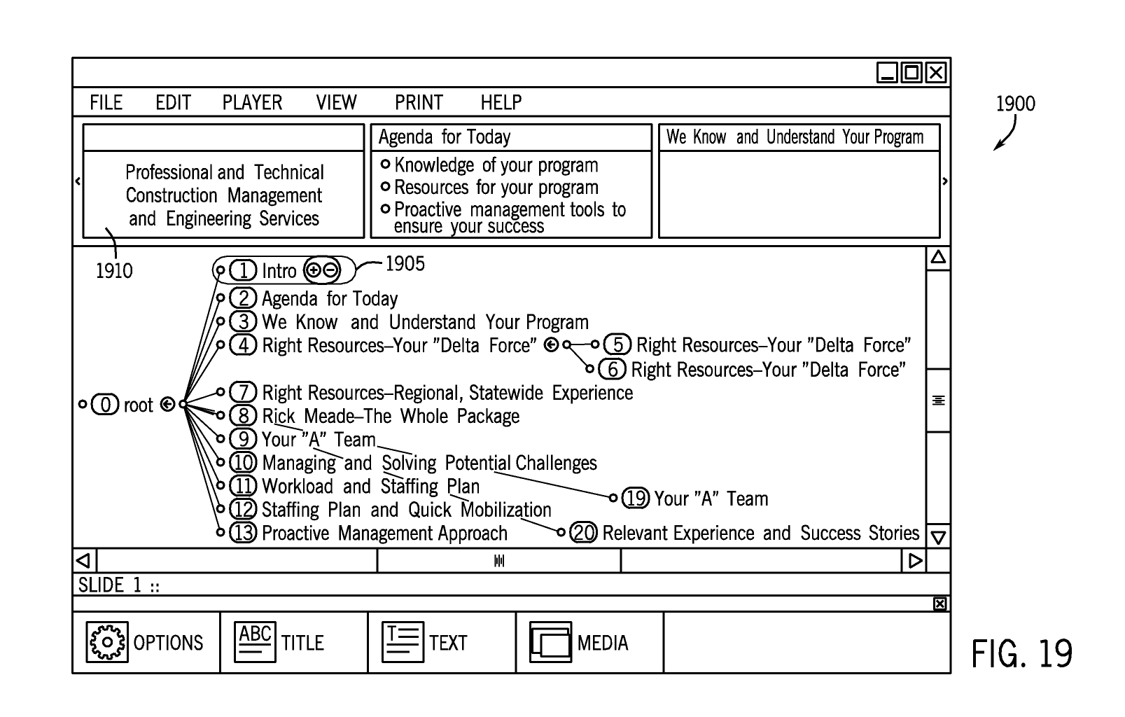

FIG. 19 shows an exemplary editing interface 1900 having a tree pane with a plurality of nodes or slides organized according to a tree relationship and a preview pane with slide previews organized according to a linear relationship. According to one exemplary embodiment, FIG. 19 may be similar to what may appear if a node is selected in the tree pane of editing interface 1800. Slide 1905 is illustrated as having been selected by a user. The selection is shown by a darkened bubble around the representation of slide 1905. In other embodiments, selection of a slide or node may be represented in different ways, such as changes in color, font, size, position, highlighting, etc. In some embodiments, the preview pane may be a fixed pane on an editing screen. In other embodiments, the preview pane may be hidden until a slide is selected in the tree pane. Slide 1910 appearing in the preview pane is a preview slide of selected slide 1905 in the tree pane. The slides appearing next to slide 1910 may be the next slides in a linear relationship.

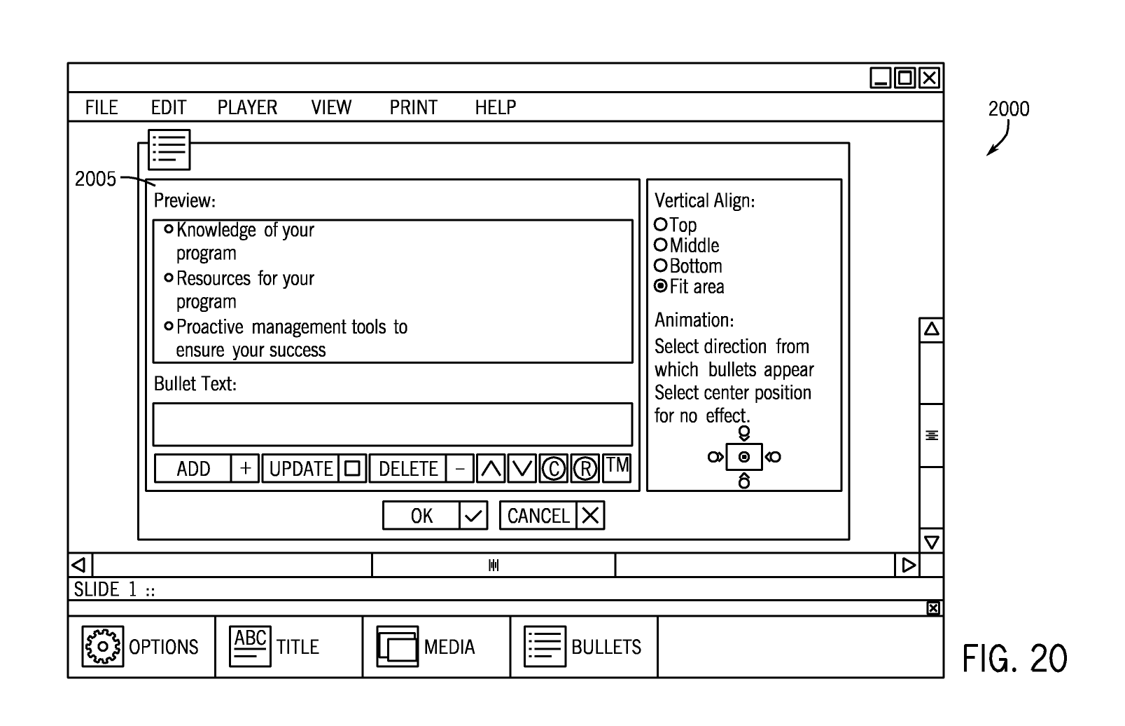

FIG. 20 shows an exemplary editing interface 2000 having a bullet property panel 2005. Bullet property panel 2005 has a plurality of properties related to the appearance of bullets in a presentation. Bullet property panel 2005 has options to set the vertical alignment of bullets (top, middle, bottom, fit area), determine an animation and/or direction of movement when bullets appear during the presentation, and set text associated with the bullets. Bullet property panel 2005 also displays a preview of the appearance of bullets in the presentation. In other embodiments, more, less or different options may be present, such as color, size, indentation, etc.

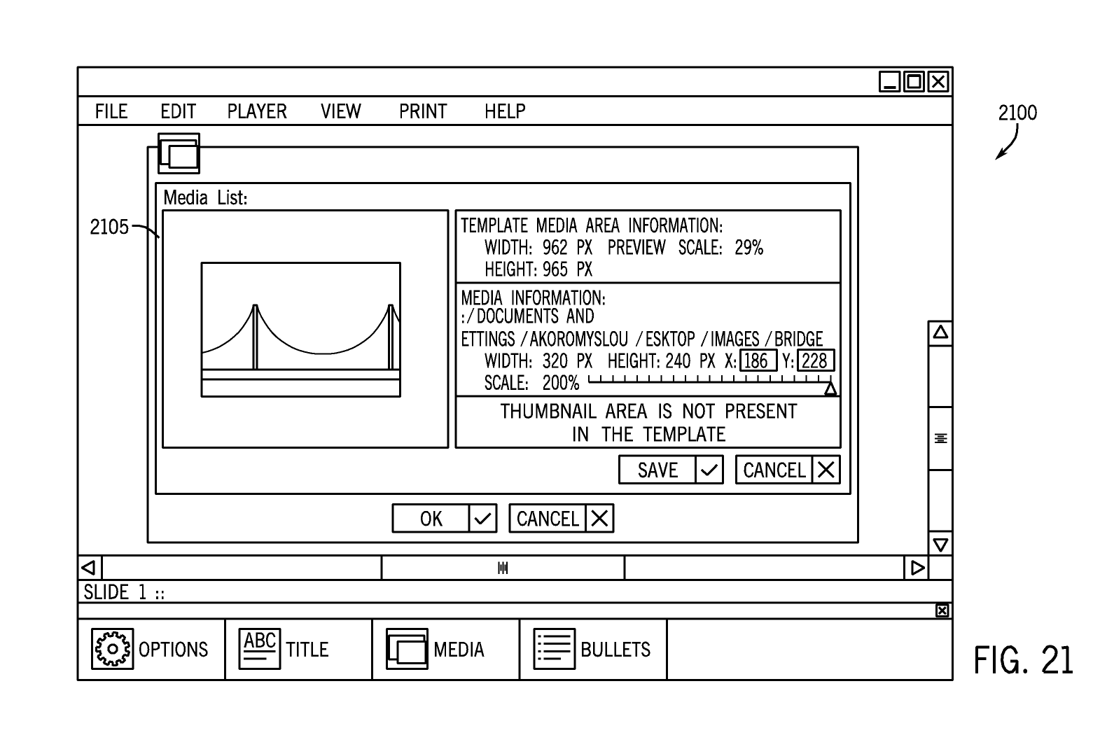

FIG. 21 shows an exemplary editing interface 2100 having a media property panel 2105. Media property panel 2105 has a plurality of properties related to media (e.g., videos, images, etc.) associated with and/or embedded in the slides of a presentation. Media property panel 2105 may display different properties based on the type of media selected. For example, in FIG. 21 an image is selected, and media property panel 2105 displays a preview of the image, template media area information such as the width and height (in pixels, metric or English units of distance, etc.) and the scale percentage of the preview to the original image file. Media property panel 2105 also displays media information such as the location of the image file in a memory, width and height of the image, horizontal and/or vertical coordinates representing the position of the image on a slide, and a selectable scale percentage of the original image to the image shown in the slide. Different information and options may be presented for different types of media, such as videos. In other embodiments, more, less or different information and options may be present, such as size of a media file in memory, image properties such as brightness or contrast, resolution, image and/or video editing tools such as cropping, video length, etc.

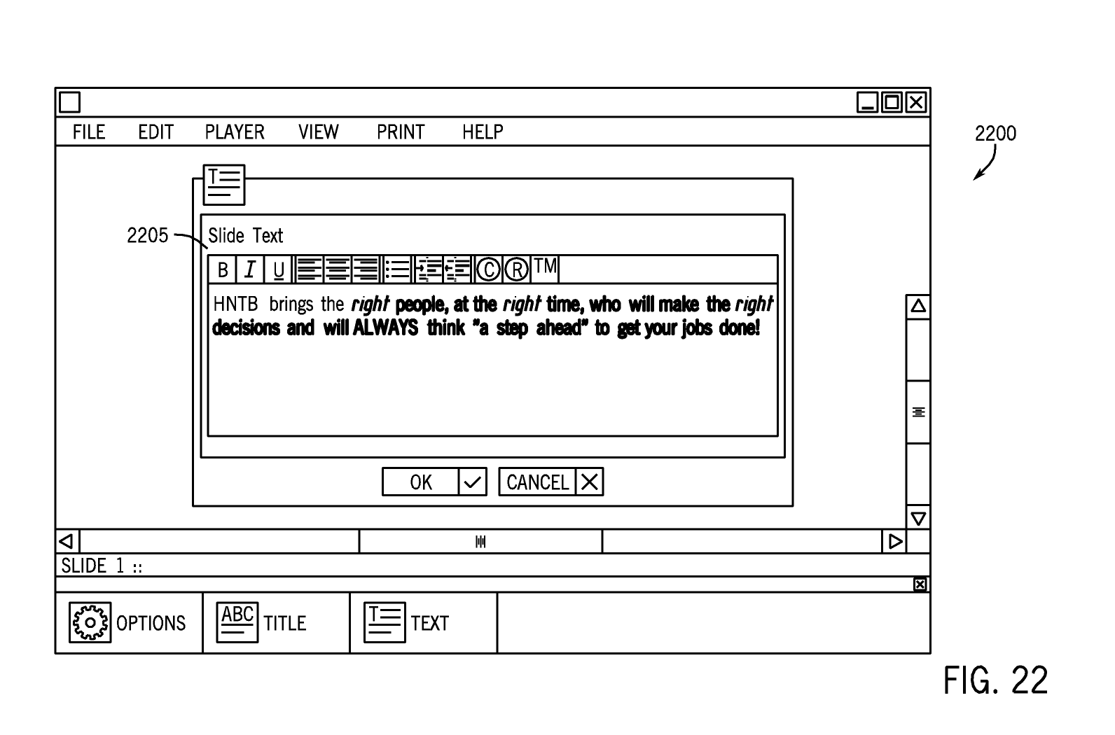

FIG. 22 shows an exemplary editing interface 2200 having a text property panel 2205. Text property panel 2205 has a plurality of properties related to slide text. Text property panel 2205 permits a user to enter text, change the font style (bold, italicize, underline, etc.), set the text orientation or justification (right, left, center), add bullets, increase or decrease indentation, and add special characters (copyright symbol, trademark symbols, etc.). In other embodiments, more, less or different options may be presented, such as font type, color, size, etc.

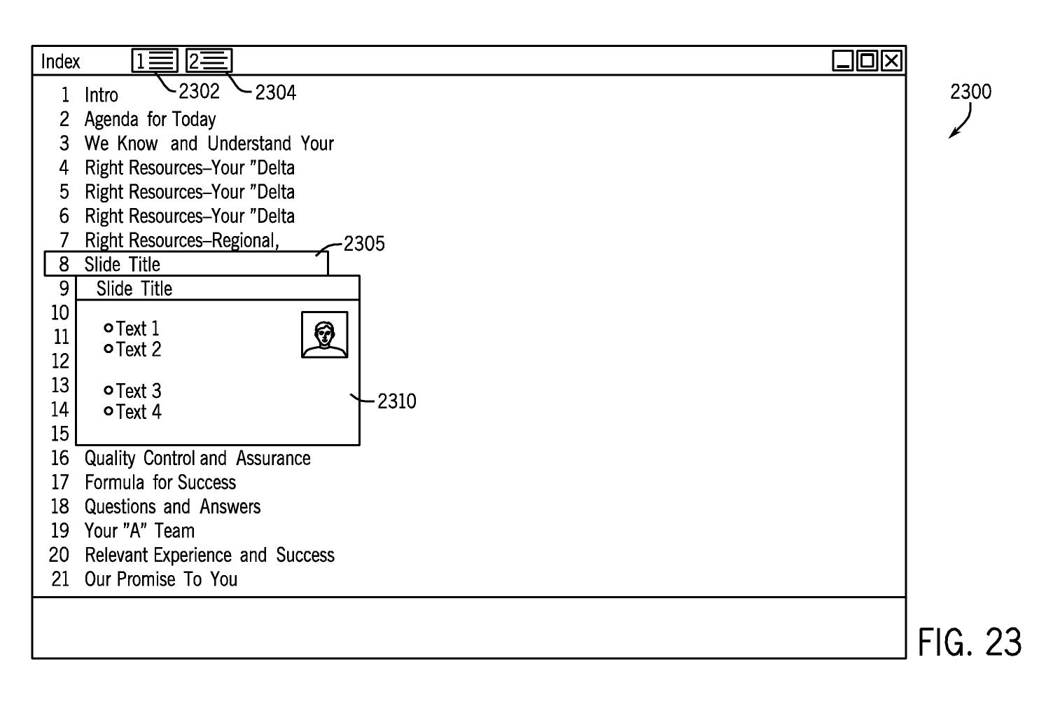

FIG. 23 shows an exemplary index 2300 that may appear within an editing interface or a player or presentation interface. Index 2300 includes a visual representation of one or more slides of a presentation. The slides may be ordered in a list according to at least one of a linear relationship and/or a tree relationship. All slides may appear at one level of indentation, or one or more slides may appear at differing levels of indentation. In some embodiments, differing levels of indentation may represent different hierarchical levels based on the tree structure. In various embodiments, methods other than differing indentation may be used, such as differences in font, color, size, etc.

In some embodiments, index 2300 may have multiple views selectable by a user. One or more of the views may be based on the linear relationship and/or tree relationship. Index 2300, as shown, has a linear view in which all slides appear at the same level of indentation. The linear view indicates the linear relationship between the slides and/or the order in which the slides will appear in a linear presentation. In some embodiments, index 2300 may have a tree or hierarchy view in which slides appear at different levels of hierarchy (e.g., by indentation) based on the tree relationship. The tree view may show a visual representation of parent-child relationships between slides. In some embodiments, users may toggle between a linear view and a tree view. For example, by clicking linear view command button 2302 in index 2300 a user may be presented with the linear view of index 2300. By clicking tree view command button 2304 a user may be presented with the tree view of index 2300.

In some embodiments, a user may view a preview of a slide by selecting the slide with a user input device. Slide 2305 has been selected by a user in the exemplary embodiment shown in FIG. 23, as is indicated by the light rectangular box around the visual representation of slide 2305. In other embodiments, other methods of indicating selection of a slide may be used. Slide preview 2310 may appear in response to the selection of slide 2305 and may be a preview image of slide 2305. In other embodiments, other information may appear when a slide is selected, such as media embedded in the slide.

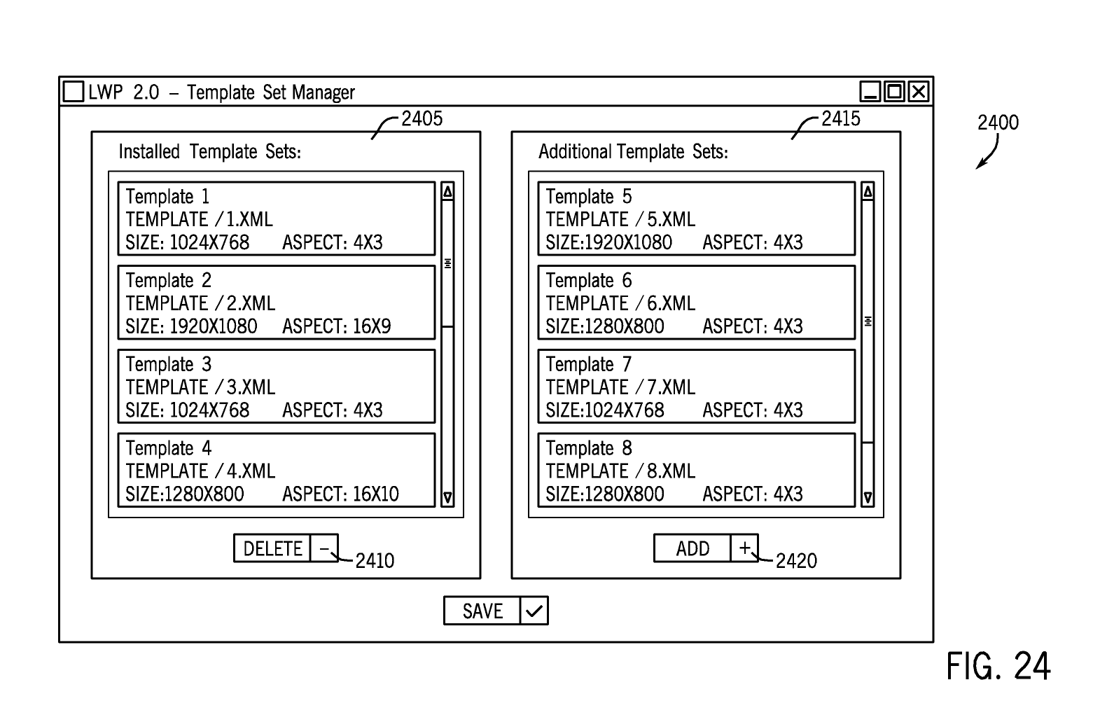

FIG. 24 shows an exemplary template management panel 2400 that may be used with an editing interface. Template management panel 2400 may include an installed template list 2405 that lists slide templates installed on a system. Each template entry in the slide template list may include information about the template and/or slides that may be created using the template, such as a title, location of the file (e.g., in local memory, remote memory such as on a network drive, Internet URL, etc.), size of slides in the template (e.g., in pixels, metric or English size units, etc.), aspect ratio of the slides, etc. Template management panel 2400 may have a delete command button 2410 that may allow a user to delete an installed template set. Template management panel 2400 may include an additional template list 2415 that lists available slide templates not installed on the system. Additional template list 2415 may include information about available templates that may be similar to or different from the information in installed template list 2405. Template management panel 2400 may include an add command button 2420 that may allow a user to add and/or install an additional template selected from additional template list 2415.

Player with Navigation Pane

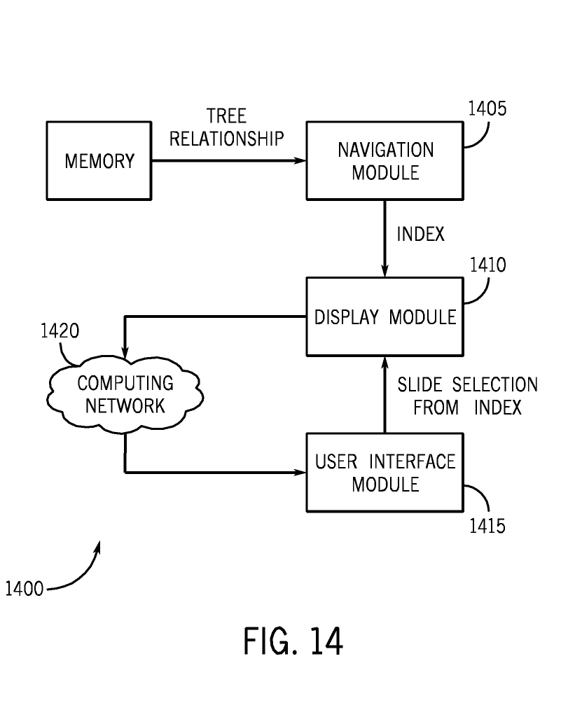

Referring now to FIG. 14, a block diagram of a presentation system 1400 is shown, according to an exemplary embodiment. Presentation system 1400 includes a navigation module 1405, a display module 1410, and a user interface module 1415. Navigation module 1405 is configured to receive a tree relationship for the slides of a presentation from a memory and generate a navigation pane based on the tree relationship. Display module 1410 is configured to display the navigation pane. User interface module 1415 is configured to allow a user of presentation system 1400 to select a slide from the navigation pane. Display module 1410 is then configured to display the selected slide.

Navigation module 1405 is configured to generate, create and/or organize a slide navigation pane based on the tree relationship received from memory. In some embodiments, the navigation pane may include an index (e.g., the index shown in FIG. 23). The navigation pane may include a representation of each slide in the presentation. In some embodiments, the navigation pane may be limited to include only slides at, above, or below a certain hierarchical level (e.g., only first parents, only first parents and first children, etc.). The navigation pane may be organized as any structure capable of preserving the hierarchical or parent-child relationships between the slides (e.g., tree, stack, queue, linked list, etc.). The navigation pane may include a link to each slide in the presentation. In some embodiments, each time a title is added to a slide, a node or structure in the hierarchy is automatically built. In some embodiments, display module 1410 may present a user with a visual category enumerator that may be selected to see a category name or jump to a category slide presentation. This visual category enumerator may include names and/or images associated with categories. In some embodiments users may use keyboard commands to proceed through the slides and/or navigation pane. In some embodiments media and/or image files played and/or displayed using system 1400 may be embedded in the presentation and may not require system 1400 to switch to a separate application to play and/or display the files. System 1400 may allow a user to view content such as an image or video on a partial screen or a full screen view and/or within a slide or in a separate window. System 1400 may be configured to return directly to the slide in which the content is embedded once the user is done viewing the content, either automatically or upon input from the user. System 1400 may incorporate video, image, spreadsheet and other programs for viewing and/or manipulating slide content such that the content may be viewed and manipulated directly in the presentation. In some embodiments, such programs may be included as components of system 1400. For example, in one embodiment system 1400 may include an Adobe Flash component, available from Adobe Systems Inc. of San Jose, Calif., to display Flash video during a presentation.

Display module 1410 is configured to display the navigation pane. In displaying the navigation pane, display module 1410 is configured to display a representation of each slide in the navigation pane according to a hierarchical structure based at least on the tree relationship. For example, display module 1410 may be configured to display the title of each slide in the navigation pane. In other embodiments, display module 1410 may be configured to display a brief description of each slide in the navigation pane. In still further embodiments, display module 1410 may be configured to display thumbnail images of each slide in the navigation pane (e.g., a first image of a video, a beginning portion of the video which plays in the thumbnail, etc.). In some embodiments, system 1400 may be configured to provide thumbnail images in no more than three seconds. The navigation pane may be displayed in any format. In some embodiments, display module 1410 may be configured to display the navigation pane in a format that indicates the hierarchical relationship between the slides to a user. For example, in one embodiment, display module 1410 may display the representations of the slides with indentations to indicate parent-child relationships between the slides. One exemplary navigation pane according to such an embodiment may look similar to the navigation pane shown in FIG. 13. In other embodiments, display module 1410 may display the navigation pane in a tree structure. In other embodiments, display module 1410 may distinguish between hierarchy levels in the navigation pane through the use of different fonts, text sizes, text colors, bolding, underlining, italicizing, highlighting, etc. In some embodiments, system 1400 may support an unlimited number of hierarchy levels. In some embodiments, display module 1410 may display a preview of a slide based on input received by user interface module 1415 when the navigation pane is displayed. For example, display module 1410 may display a thumbnail preview of a slide in response to a right-click or mouse-over from a computer mouse. In some embodiments, display module 1410 may display a preview in response to a movement of a finger, pen, or other pointing object on or near a display screen.

User interface module 1415 is configured to receive a user selection of a slide from the navigation pane at any of a plurality of levels of hierarchy in the hierarchical structure to be displayed by display module 1410. In one embodiment, a user may select a single slide to indicate a starting slide for use in a linear or tree-based presentation format. In other embodiments, a user may select a plurality of slides to indicate that the presentation should be limited to the selected slides and/or related slides in the hierarchical structure. User interface module 1415 may also be configured to allow a user to display the navigation pane at any point in a presentation. For example, display module 1410 may be configured to display a button, box, link, label, etc. indicative of the navigation pane and user interface module 1415 may be configured to command display module 1410 to display the navigation pane in response to user selection of the navigation pane indicator. In some embodiments, user interface module 1415 may be configured to command display module 1410 to display the navigation pane in response to a key or key combination from a keyboard, such as a hot key which may act as a toggle to display or not display the navigation pane in a window pane (which may be less than the full screen), in a full screen, etc.

In some embodiments, display module 1410 may be configured to determine the information displayed in the navigation pane based on user input received by user interface module 1415. For example, in some embodiments, display module 1410 may be configured to display only information related to slides at, above or below a certain level of hierarchy specified by a user. For example, in one embodiment a user may command display module 1410 to display only slides within the top three levels of hierarchy. In other embodiments, display module 1410 may be configured to display only information having a particular level of detail specified by a user (e.g., display categories and not details below the categories). Display module 1410 may be configured to hide one or more slides based on the user input received by user interface module 1415. In still further embodiments, display module 1410 may be configured to allow a user to customize information displayed in the navigation pane based on other input provided to user input module 1415.

In further embodiments, display module 1410 may be configured to display the navigation pane after the last slide in a branch of the tree relationship is displayed. For example, if an exemplary presentation has a plurality of main topics represented by a plurality of primary parent slides, display module 1410 may display the navigation pane after the last slide related to the first primary parent slide is displayed. This may be used to hide certain slides or flow around them during a presentation. In some embodiments, a single presentation may be used several times and altered by hiding slides the presenter does not wish to present, with the system storing predefined selections of one or more subsets of the slides for presentation. Display module 1410 may also be configured to display the navigation pane after the last slide of the presentation has been displayed. In other embodiments, display module 1410 may be configured to proceed from one branch of slides to another without displaying the navigation pane.

In still further embodiments, presentation system 1400 may be operable on one or more server computers, and may be configured to communicate with a computing network 1420. Display module 1410 may be configured to display a presentation on one or more displays connected to computing network 1420. User interface module 1415 may be configured to receive input from one or more users of the presentation at a client computer over computing network 1420, and display module 1410 may be configured to change what is displayed at the client computer based on the input. Computing network 1420 may be any communication network (e.g., LAN, WAN, wired, wireless, satellite, cable, DSL, etc.). Computing network 1420 may be a global computing network such as the Internet. Navigation module 1405, display module 1410 and user interface module 1415 may be implemented as software (e.g., HTML, XML, Java, Flash, etc.) compatible with web browsers (e.g., Internet Explorer, Firefox, Opera, Safari, etc.). Presentation system 1400 may be configured to be accessible from a client computer via a resource locator (e.g., a uniform resource locator), which may direct the client to a secure hypertext transfer protocol web site.

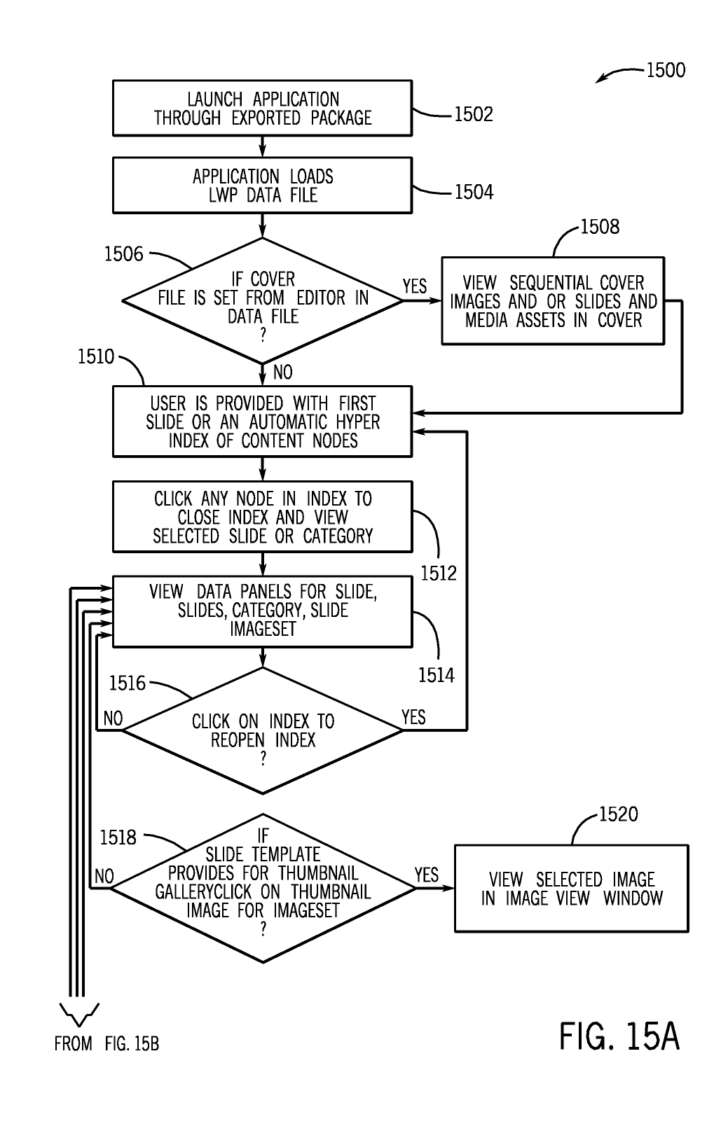

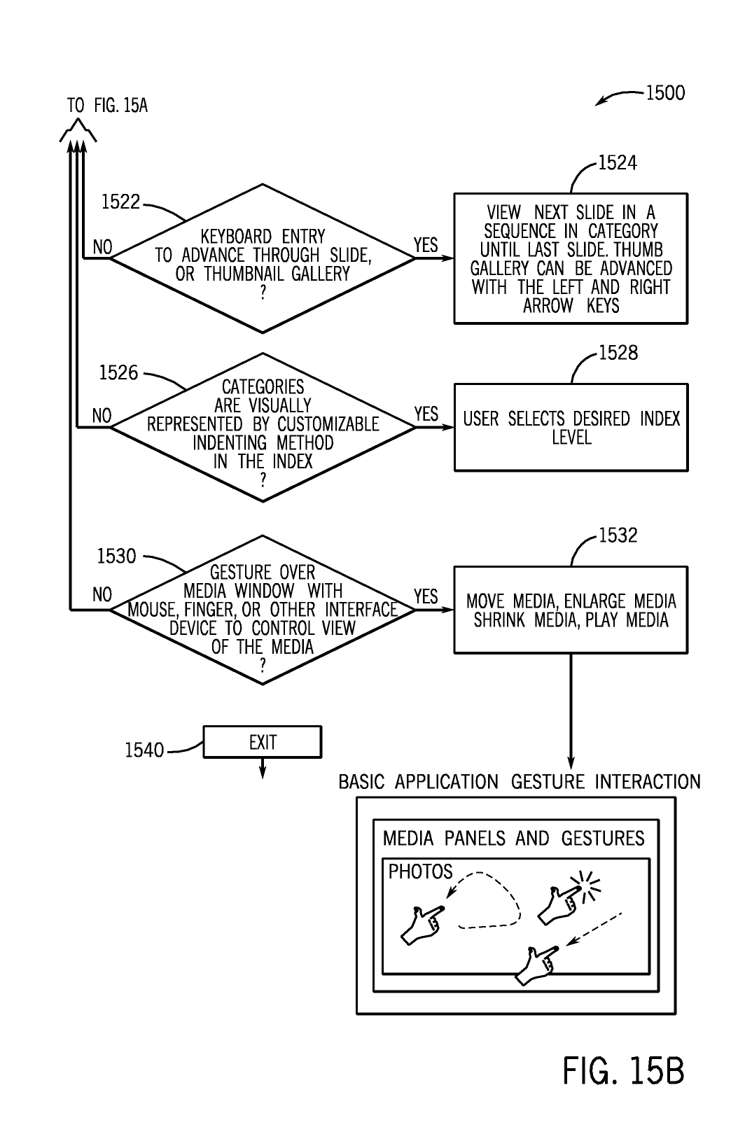

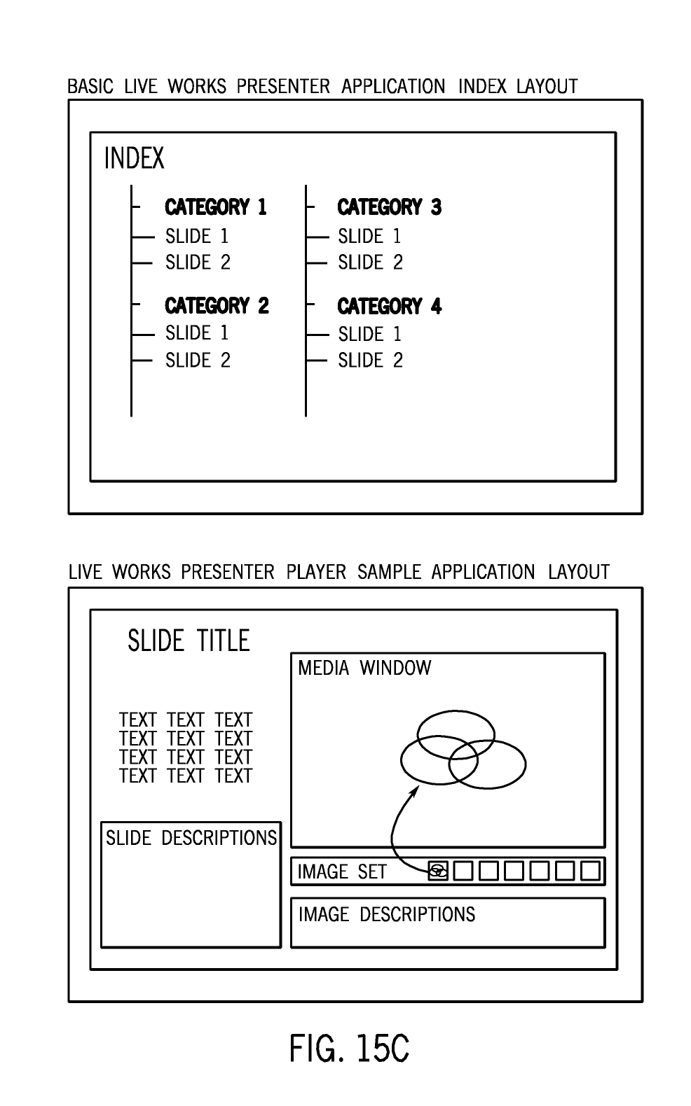

Referring now to FIG. 15, a process flow diagram of a process 1500 that may be used with presentation system 1400 is shown, according to an exemplary embodiment. At step 1502, system 1400 launches a player or presentation interface. The player interface may be launched through an exported package. At step 1504, system 1400 loads the presentation data file. At step 1506, system 1400 determines whether a cover file is included in the data file from an editor interface. If so, system 1400 proceeds to step 1508 and displays the cover image and/or slides and media content or assets in the cover file, then proceeds to step 1510. If not, system 1400 proceeds to step 1510.

At step 1510, the user is provided with either the first slide in the presentation or an navigation pane of content nodes. The navigation pane may be organized according to a hierarchy and may be linked to each of the slides of the presentation. At step 1512, the user may select any slide or node in the navigation pane to close the navigation pane and view the selected slide or category. At step 1514, the user may view data panels for one or more slides, categories and/or slide content.

At step 1516, user interface module 1415 determines whether a user command to reopen the navigation pane has been received. If so, system 1400 returns to step 1510. If not, system 1400 returns to step 1514.

At step 1518, user interface module 1415 determines whether the user has selected to view an image in a new window. If so, system 1400 proceeds to step 1520 and display module 1410 displays the selected image in an image view window. If not, system 1400 returns to step 1514.

At step 1522, user interface module 1415 determines whether a user has selected to advance through each slide or through a thumbnail gallery. If so, system 1400 proceeds to step 1524 and display module 1410 displays the slides and/or thumbnail gallery images in sequence. If not, system 1400 returns to step 1514.

At step 1526, system 1400 determines whether the categories, slides and/or media content or assets are visually represented by a customizable indexing method in the navigation pane. If so, system 1400 proceeds to step 1528 and a user may select a desired navigation pane level. If not, system 1400 returns to step 1514.

At step 1530, user interface module 1415 determines whether the user has moved a user input device, including a mouse, human finger or other device, over a display to control the view of the slides or media. If so, system 1400 proceeds to step 1532 and the user may move or pan the slide or media, enlarge or shrink the slide or media, and/or play the media via user interface module 1415. FIG. 15 also includes an exemplary diagram of possible user input device interaction that may be used by a user in conjunction with steps 1530 and 1532. At step 1540, a user may exit system 1400.

Modeless/Presentation Window Controlled by Editor

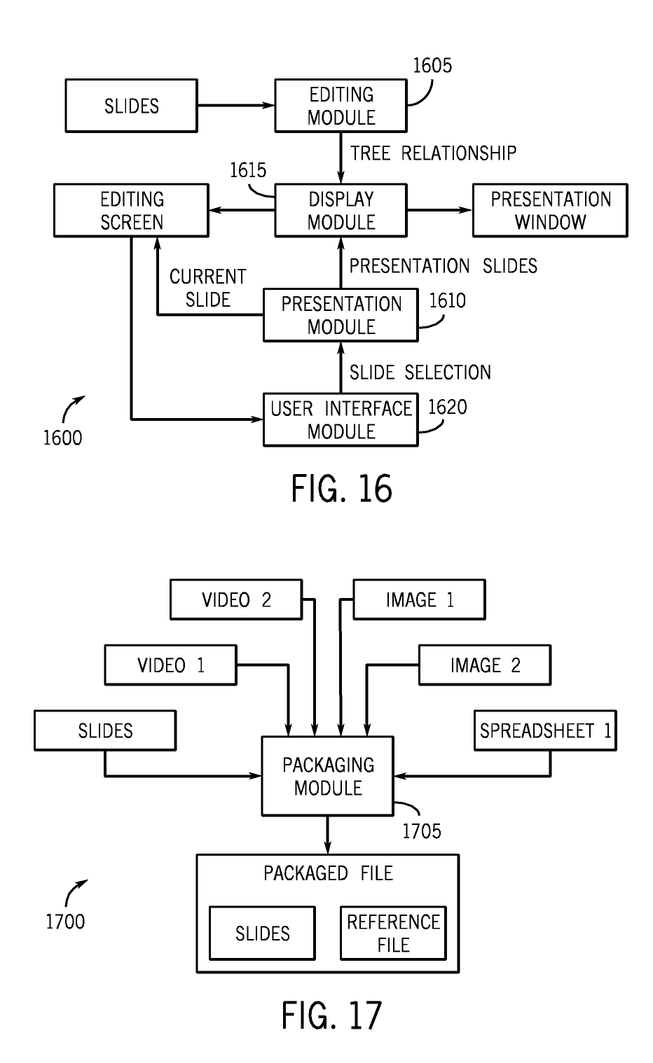

Referring now to FIG. 16, a block diagram of a presentation system 1600 is shown, according to an exemplary embodiment. Presentation system 1600 includes an editing module 1605, a presentation module 1610, a display module 1615, and a user interface module 1620. Editing module 1605 is configured to assign a tree relationship to the slides of a presentation. Presentation module 1610 is configured to determine a first slide to display for the presentation. Display module 1615 is configured to display a visual representation of the tree relationship on an editing screen and the first slide determined by presentation module 1610 in a presentation window. User interface module 1620 is configured to allow a user to select a slide based at least on the visual representation of the tree relationship displayed on the editing screen. Presentation module 1610 is then configured to determine a second slide to display for the presentation based on the slide selected by the user. Presentation system 1600 may allow a user to launch a player or presentation interface including the presentation window from an editing interface including the editing screen. In some embodiments, a user may run a presentation in the player interface or use the editor interface with a modeless window or presentation window control. A modeless window may refer to a window that remains active until it is dismissed, or operates independently of a screen or window which may have created it. The editor interface and player interface may be configured to run simultaneously with navigation of the slides being controllable by either the player interface or the editor interface. The editor interface and player interface may be configured to work together to provide streamlined editing and playback functionality.

Presentation module 1610 is configured to determine a first slide to display for the presentation. In some embodiments, the first slide may be determined based on user input. In other embodiments, the first slide may be determined based on the tree relationship assigned to the slides by editing module 1605.

Display module 1615 is configured to display a visual representation of the tree relationship on an editing screen and display the first slide in a presentation window. The editing screen and/or presentation window may be displayed automatically by display module 1615 or may be displayed in response to input received from a user at user interface module 1620. For example, the editing screen may be configured to display automatically upon starting presentation system 1600 and the presentation screen may appear only after a user has sent a command to user interface module 1620 to open the presentation screen. In some embodiments, the editing screen and the presentation window may occupy portions of the same screen on the same display. In other embodiments, the editing screen and presentation window may be displayed on separate screens and/or windows on the same display. In still further embodiments, the editing screen and presentation window may be displayed on separate displays.

User interface module 1620 is configured to allow a user to select a slide based on the visual representation of the tree relationship displayed on the editing screen. For example, user interface module 1620 may receive input indicating that a user has selected a slide on a tree structure displayed on the editing screen. Presentation module 1610 is configured to determine a second slide for display based on the user's selection. In some embodiments, user interface module 1620 may also be configured to allow a user to select a slide in the presentation window, such as by selecting a slide from a navigation pane and/or index. Editing module 1605 may be configured to receive an input from presentation module 1610 representing a currently displayed slide that is being displayed in the presentation window.

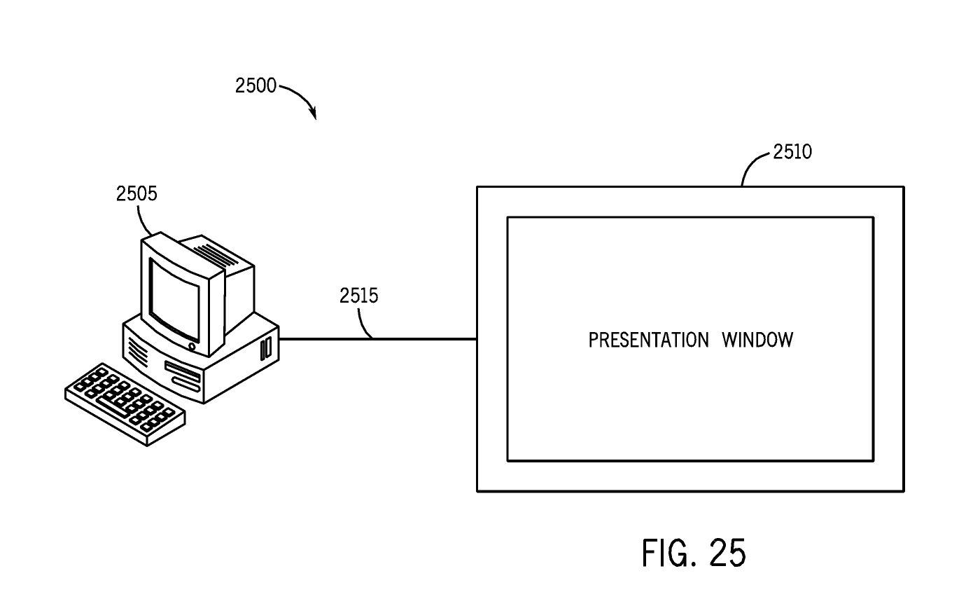

Referring now to FIG. 25, a graphical depiction of a presentation system 2500 is shown, according to an exemplary embodiment. Presentation system 2500 includes an editing computer 2505 configured to display an editing screen. Presentation system 2500 further includes a presentation display 2510 configured to display a presentation window. Presentation display 2510 may be a large screen electronic display such as those described herein. Editing computer 2505 and presentation display 2510 communicate via interface 2515. Interface 2515 may be any interface through which a computer may communicate with another computer and/or a display (e.g., VGA, DVI, HDMI, composite/RCA audio/video cables, component video cables, USB, Firewire, Ethernet, wireless (e.g., IEEE 802.11a/b/g/n, Bluetooth, etc.), etc.). A user may use editing computer 2505 to make changes to a presentation and/or select slides for viewing in the presentation window on presentation display 2510 using the editing screen displayed on editing computer 2505. In some embodiments, a user may use editing computer 2505 to alter a presentation while the presentation is being delivered by another person who is using presentation display 2510. Presentation display 2510 may have a touch screen or other device allowing user input on or near presentation display 2510 as described herein. A user may be able to use the to make changes to a presentation directly on presentation display 2510 or send changes to editing computer 2505.

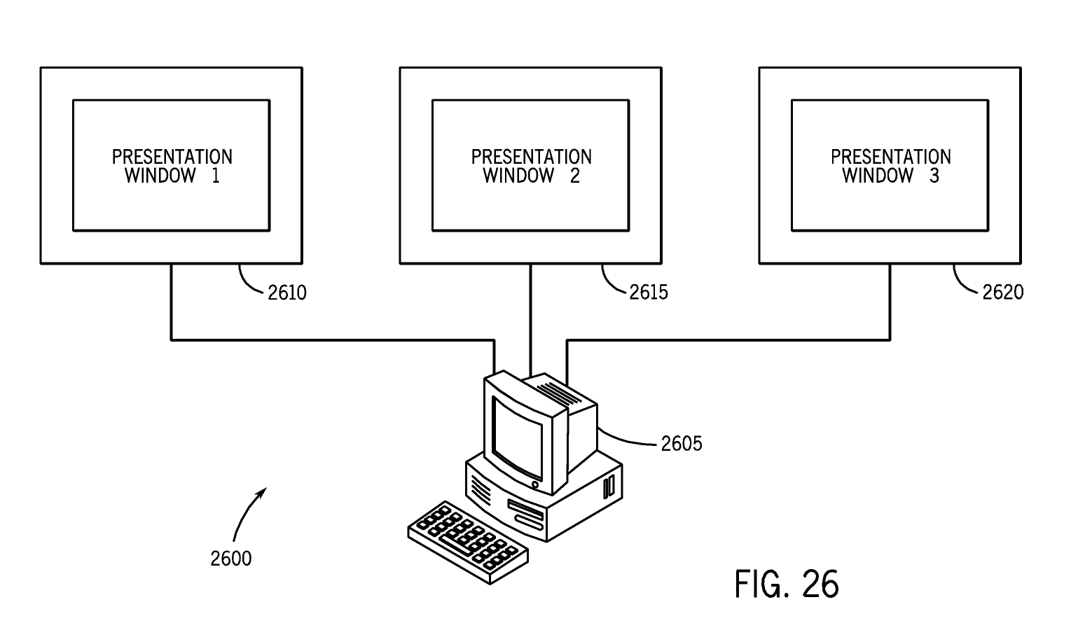

Referring now to FIG. 26, a graphical depiction of a presentation system 2600 is shown, according to an exemplary embodiment. Presentation system 2600 includes an editing computer 2605 configured to display an editing screen. Presentation system 2600 further includes a plurality of presentation displays 2610, 2615 and 2620 each configured to display one or a plurality of presentation windows. Each of presentation displays 2610, 2615 and 2620 may be a large screen electronic display such as those described herein. Presentation displays 2610, 2615 and 2620 may have touch screens or other devices allowing user input on or near displays 2610, 2615 and 2620 as described herein. A user may be able to use the to make changes to a presentation directly on one or more of displays 2610, 2615 and 2620 or send changes to editing computer 2605. In various embodiments, displays 2610, 2615 and 2620 may have the same or different features, such as size, color, model, resolution, refresh rate, etc. Each of displays 2610, 2615 and 2620 may be configured to display a different presentation window. A presentation module, such as presentation module 1610, may be configured to determine different slides to display in each presentation window. In some embodiments, the presentation windows shown in displays 2610, 2615 and 2620 may be linked or synchronized such that changes made to the slides of one presentation window using the editing screen of editing computer 2605 may result in changes to the slides of one or more of the other presentation windows. For example, if a different slide is selected in the first presentation window shown on display 2610 the slides displayed on the second and/or third presentation windows shown on displays 2615 and 2620, respectively, may be changed. In other embodiments, changes made by a user or presenter on one of the presentation windows, for example using a system such as presentation system 100, may change what is displayed on one or more of the other presentation windows. Slides displayed in two or more presentation windows may be changed based on user commands to move forward or backward, select a slide in a navigation pane or index, select a slide in a tree representation on the editing screen, etc. with respect to the presentation displayed on one of the presentation windows. In some embodiments, the content displayed on each of the presentation screens has the same number of screens and/or slides. In further embodiments, the content on the slides may be similar in structure and/or may have been created using a common template.

In some embodiments, the presentation displayed in one of the presentation windows is a base or primary presentation on which the slides displayed in the other presentation windows are based. For example, the slides displayed in the first presentation window on display 2610 may be the primary slides and the content of the slides displayed in the presentation windows of displays 2615 and 2620 may be based on the content of the primary slides. In some embodiments, editing computer 2605 may allow a user to spawn slides and/or structure for the non-primary presentation windows based on the primary slides. Content displayed in each of the presentation windows may be assigned manually or automatically. For example, the slides or presentations may be assigned identifiers, such as numerical values, corresponding to the presentation window on which they are to be displayed. In other embodiments, a user may drag slides to one or more presentation windows using a drag and drop interface on the editing screen and/or one of the presentation windows.

In some embodiments, slides shown on one or more of displays 2610, 2615 and 2620 may be hidden during a presentation. In some embodiments, a slide may be hidden on one of displays 2610, 2615 and 2620 during a presentation while slides are displayed on one or more of the other displays. In other embodiments, hiding a slide on one of displays 2610, 2615 and 2620 may cause linked slides on one or more of the other displays to be hidden during a presentation as well. In some embodiments, options regarding the hiding of linked slides (e.g., what slides are hidden when one slide is selected to be hidden, how a hidden slide is represented in the displayed presentation, etc.) may be selectable by a user using editing computer 2605 and/or user input on or near displays 2610, 2615 and 2620.

Export

Referring now to FIG. 17, a packaging system 1700 for packaging files related to a presentation is shown, according to an exemplary embodiment. Packaging system 1700 includes a packaging module 1705 configured to package files related to a presentation into a packaged file. The files include the slides used in the presentation. The files may also include other content used in the presentation, such as video files (MPEG, XVID, AVI, WMV, Flash, Quicktime, etc.), audio files (MP3, WMA, AAC, MIDI, MPA, etc.), image or picture files (JPG, BMP, GIF, TIF, PNG, etc.), spreadsheets, flowcharts, block diagrams, etc. Packaging system 1700 is configured to create a packaged file that can be used, for example, to export the presentation to users. The files contained in the packaged file may have relative links.

Packaging module 1705 is configured to package the files into a packaged file such that the files packaged within the packaged file each have a file format that is the same as their respective file format before being packaged. In some embodiments, packaging module 1705 may package the files into a zip file. In other embodiments, packaging module 1705 may utilize other file compression and/or packaging formats, such as RAR. In still further embodiments, packaging module 1705 may package the files using a proprietary packaging format specific to packaging system 1700. In some embodiments, the reference file may not be a binary file that packages all the files into a single file with one format. A user may be able to retrieve each individual original content file from the packaged file.

The files also include a reference file that can be used by a presentation module to reconstruct the presentation from the packaged file. The reference file may indicate a relationship between the files packaged in the packaged file. For example, the reference file may indicate in what slides and in what manner video, audio, images, etc. contained in the packaged file are used. In some embodiments, the reference file may be an XML file. Using the reference file, a user may import the presentation into a presentation system and edit the original content files used in the presentation. The reference file may be configured such that the user is not required the reconstruct the original content files from the presentation in order to edit content embedded in the presentation.

According to one exemplary embodiment, a system for packaging files related to a presentation comprises a packaging module. The packaging module is configured to package the files into a packaged file. The files include the slides used in the presentation. The files packaged within the packaged file each have a file format that is the same as its respective file format before being packaged. The files include a reference file that can be used by a presentation module to reconstruct the presentation from the packaged file. In some embodiments, the reference file is an XML file.

The systems described herein comprise units, modules, circuits or circuit portions, mechanisms, or devices, as part of a machine or apparatus, each of which performs one or more of the processes or functions described herein. Each such unit may comprise a computer program portion, code, software, or other computer-readable data or instructions operating on suitable electronic circuitry, which may be general-purpose or specific-purpose circuitry and may include one or more microprocessors, microcontrollers, application-specific integrated circuitry, programmable logic, or other analog and/or digital circuit elements. The code may be stored in or on a computer-readable medium, such as a memory (e.g., compact disk, digital versatile disk, computer memory, such as read-only memory, programmable read-only memory, flash memory, magnetic drive, hard drive, tape drive, firmware, or any other memory) which memory may be accessed by or configured to be read or operated by a processor to operate the code or be configured to transfer the code (e.g., via electronic transmission, wireless transmission, or physical transmission, such as via a retail store or in a package delivered through the mail) to another computer-readable medium (e.g., a memory) for operation by another processor (e.g., a processor associated with the memory or otherwise configured to read the memory). In any case, the computer program is configured to cause the processor operating the program to provide one or more of the functions, processes, or steps described herein. The organization of the units as set forth in the figures is exemplary and in practice the functions may be organized in modules, objects or routines different than as set forth in the figures, or the units may share certain functions described herein. The code may be programmed in any of a variety of programming languages, such as FORTRAN, C, C++, C#, Java, etc., and may comprise machine code, source code, object code, or other types of code.

While the detailed drawings, specific examples and particular formulations given describe exemplary embodiments, they serve the purpose of illustration only. The hardware and software configurations shown and described may differ depending on the chosen performance characteristics and physical characteristics of the computing devices. The systems shown and described are not limited to the precise details and conditions disclosed. Furthermore, other substitutions, modifications, changes, and omissions may be made in the design, operating conditions, and arrangement of the exemplary embodiments without departing from the scope of the present disclosure as expressed in the appended claims.

What is claimed is:

1. A system for displaying slides of a presentation, comprising:
an editor module configured to generate a slide for the presentation based at least on content defined by a user;
a display module configured to generate display data for the presentation, wherein the display data represents the slide of the presentation; and
a user interface module configured to receive a selection of a portion of the slide based at least on a detected movement of a user input device across the slide,
wherein the display module is configured to enlarge the selected portion of the slide on the display in response to at least the movement of the user input device across the slide.

2. The system of claim 1, wherein the display module is configured to pan the slide based on at least one further user input.

3. The system of claim 1, wherein the display module is further configured to enlarge the selected portion of the slide based at least on a predetermined display characteristic.

4. The system of claim 3, wherein the predetermined display characteristic is an aspect ratio of the display.

5. The system of claim 1, wherein the user input module is configured to receive the selection from a sensor, wherein the sensor is configured to sense the movement of the user input device on or near the display.

6. A system for organizing slides related to a presentation, comprising:
an editing module configured to assign both a linear relationship and a tree relationship to each slide;
a display module configured to present the slides linearly and to display the tree relationship of the slides; and
a user input module configured to receive a user selection of a node of the displayed tree relationship,
wherein the display module is configured to display a slide corresponding to the selected node in response to at least the user selection, and
wherein when a new slide is created a user is prompted to assign a tree relationship position for the new slide.

7. The system of claim 6, wherein the display module is configured to simultaneously display a visual representation of the linear relationship and the tree relationship of a plurality of slides.

8. The system of claim 7, wherein the visual representation of the linear relationship comprises a preview pane configured to preview a portion of a linear presentation based at least on a slide selected based at least on the visual representation of the tree relationship.

9. The system of claim 6, wherein the display module is configured to hide one or more slides during display of the presentation.

10. A system for presenting slides related to a presentation, comprising:
a navigation module configured to receive a tree relationship for the slides from a memory, the navigation module further configured to generate a navigation pane based at least on the tree relationship;
a display module configured to display the navigation pane, wherein the display module is further configured to display a representation of at least one slide in the navigation pane according to a hierarchical structure based at least on the tree relationship; and
a user interface module configured to receive a user selection of a slide from the navigation pane at any of a plurality of levels of hierarchy in the hierarchical structure,
wherein the display module is configured to determine the at least one slide for which a representation is displayed in the navigation pane based on a level of detail provided by a user via the user interface module, and
wherein the display module is configured to display the slide selected from the navigation pane.

11. The system of claim 10, wherein the user interface module is further configured to allow a user to display the navigation pane at any point in the presentation

12. The system of claim 10, wherein the display module is further configured to display a preview of a slide based on input received by the user interface module when the navigation pane is displayed.

13. The system of claim 10, wherein the display module is configured to display the navigation pane after the last slide in a branch of the tree relationship is displayed.

14. The system of claim 10, wherein the display module is configured to display the presentation over a computing network.

15. The system of claim 14, wherein the computing network is the Internet.

16. The system of claim 14, wherein the user interface module is further configured to receive input from a user of the presentation, wherein the display module is further configured to change what is displayed based on the input from the user.

17. A system for presenting slides related to a presentation, comprising:
an editing module configured to assign a tree relationship to the slides;
a presentation module configured to determine a first slide to display for the presentation;
a display module configured to display a visual representation of the tree relationship on an editing screen, the display module further configured to display the first slide determined by the presentation module in a presentation window; and
a user interface module configured to allow a user to select a slide based at least on the visual representation of the tree relationship displayed on the editing screen,
wherein the presentation module is further configured to determine a second slide to display for the presentation based at least on the slide selected by the user.

18. The system of claim 17, wherein the user interface module is further configured to allow a user to select a slide in the presentation window, wherein the editing module is further configured to receive an input from the presentation module representing a currently displayed slide.

19. The system of claim 17, wherein the display module is further configured to display the editing screen and the presentation window on separate displays.

20. The system of claim 17, wherein the presentation window is one of a plurality of presentation windows, wherein the display module is configured to display different slides on each of the plurality of presentation windows, wherein the slides displayed on the plurality of presentation windows are linked such that changing the slide displayed on one of the presentation windows changes the slide displayed on at least one of the other presentation windows.
